(19) United States
(12) Patent Application Publication
(10) Pub. No.: US 2002/0120760 A1
(43) Pub. Date: Aug. 29, 2002

(54) Communications protocol

(76) Inventors: Gur Kimchi, New York, NY (US); Dror Tirosh, Raanana (IL); Eran Shttegman, New York, NY (US); Omer Luzzatti, New York, NY (US)

Correspondence Address: ROSENMAN & COLIN LLP, 575 MADISON AVENUE, NEW YORK, NY, 10022-2585, US

(21) Appl. No.: 09/867,371

(22) Filed: May 29, 2001

Related U.S. Application Data
(60) Provisional application No. 60/207,701, filed on May 26, 2000.

(51) Int. Cl. G06F 15/16

(52) U.S. Cl. 709/230; 709/227

(57) ABSTRACT

A transactional protocol enabling messaging, call functions, personalized communication policies, presence, and address book capabilities. The protocol is used between subscriber clients (windows specific or otherwise) and a server-based communication system. At the lowest level, the protocol uses HTTP as a transport, and a combination of a special URL format and content-information to describe intent and results. Alternate transports such as UDP, TCP, SSL, IPSEC, TLS can also be used. Transactions are taken from families of verb sets, each verb set built using a combination of generic verb headers and device/server/session specific tags. The protocol is transactional in nature and follows a pattern. That is to say that the client (in the client-server relationship, not necessarily a subscriber client) sends a request, and the server (again, not necessarily a subscriber server) replies. Generally, a client generates a verb, sends it to the server, and an appropriate handler is found on the server to take action accordingly. The verb must contain all the information that is required for the server to take action, or a reject will be returned.

### RELATED APPLICATIONS

The present application claims the benefit of provisional patent application TrulyGlobal Proprietary & Confidential, Ser. No. 60/207,701, filed May 26, 2000. In addition, this application incorporates by reference, co-pending U.S. patent application, Ser. No. 08/780,739.

### BACKGROUND OF THE INVENTION

1. Field of Invention

The present invention relates generally to the field of communications protocols. More specifically, the present invention is related to a robust HTTP based multiple function protocol.

2. Discussion of Prior Art

Most telephony services are currently provided over circuit-switched networks, known as Public Switched Telephone Networks (PSTN). This service is known as Plain Old Telephone Service (POTS). For a call using POTS service over the PSTN, a connection is reserved between the two users that does not allow any other users to use the connection. When the two users have completed the call, the call is disconnected and the line is free for other users again.

A new trend providing distinct advantages over POTS service on the PSTN is Internet telephony, also known as Voice-over-IP (VOIP) or IP telephony (IPtel). VoIP is telephony service provided over an IP-based network, i.e. a packet switched network. Providing telephony service over an IP-based network allows packets carrying data for the call to be sent between two parties without reserving connections between the parties of the call. This is accomplished by digitizing the audio signals and encapsulating them into packets and sending them across the IP-based network. At the receiving side, the packets are decapsulated and the audio is played back. Because the data is carried digitally across the IP-based network, other media, such as video and shared applications, are also capable of being incorporated into a call without major changes. Due to this fact, the term VoIP, or Internet telephony is deemed to encompass the transmission of this other media, in addition to voice. Indeed, one of the advantages of IPtel is the transparency of the network to the media carried, allowing the addition of new media types with no change to the network infrastructure.

There are many Internet telephony applications available. Some, like CoolTalk® and NetMeeting®, come bundled with popular Web browsers. Others are stand-alone products. Internet telephony products are sometimes called IP telephony, Voice over the Internet (VOI) or Voice over IP (VOIP) products.

Another benefit of IP telephony is the integration of voice and data applications. Examples of such applications are integrated voice mail and e-mail, teleconferencing, computer-based collaborative work and intelligent call distribution. This integration of applications and telephony can result in significant increases in efficiency for businesses. In addition, new services can be enabled for both businesses and customers. Personal mobility, terminal mobility and multiparty conferencing are also supported by IPtel. IP telephony seeks to provide these advantages by moving the intelligence from the network to the terminal devices, such as computers and VoIP phones.

In addition to Internet telephony, there are other Internet multimedia services, such as broadcast and media-on-demand services. The distinguishing factor between these other services and IPtel is the need for signaling functionality with IPtel. A signaling function provides for the ability to create and manage calls. Currently, there are two standards available for performing IPtel signaling and control. One is the Session Initiation Protocol (SIP) proposed by the Internet Engineering Task Force (IETF) and is part of the IETF multimedia communications protocol suite. SIP is a signaling protocol for Internet conferencing, telephony, presence, events notification and instant messaging. The protocol initiates call setup, routing, authentication and other feature messages to endpoints within an IP domain. The other is part of the H.323 standard, which is the multimedia communications protocol suite proposed by the International Telecommunication Union (ITU). H.323 defines how audiovisual conferencing data is transmitted across networks. In theory, H.323 allows users to participate in the same conference even though they are using different videoconferencing applications. Both suites use generally the same protocols for media transport, and therefore, the main difference is the signaling and control protocols.

FIG. 1 illustrates these protocols, along with the other associated protocols for performing IP telephony, and more generally, for providing multimedia services and media transport over IP networks. The model for these protocols is a layered protocol, with every layer using the services of the lower layers and providing services to the higher layers. Data is encapsulated, from the top down, with each layer adding control information for handling the packet.

The physical and link layers are generally considered as a single split layer providing for the physical interface between a data transmission device and the transmission medium or network. The protocols illustrated at the physical and link layers are well known in the art, and will not be discussed further herein. It should also be noted, however, that generally, the Ethernet protocol is the more popular protocol implemented. It should also be noted that he protocols illustrated are not exhaustive of the possible protocols at this layer.

The IP protocol, denoted by IPv4 and IPv6, is a network layer protocol, which is part of the TCP/IP protocol suit, and is the most widely utilized internetworking protocol. This is a connectionless protocol, and, as such, there is no connection established between the endpoints of the communication. Data is transmitted as packets, with each packet at the IP layer considered as an independent unit of data. The IP protocol, and the network layer in general, is primarily concerned with the exchange of data between an end system and the network to which it is attached and the routing of packets across networks.

The Transmission Control Protocol (TCP) is a connection-oriented transport layer protocol. TCP is responsible for dividing the message into packets, which IP handles and for reassembling the packets back into a complete message. The User Datagram Protocol (UDP) is a connectionless transport layer protocol. UDP is similar to TCP except that UDP does not provide sequencing of packets that the data arrives in. Therefore, higher-level protocols must be capable of ensuring that the entire message has arrived and capable of ordering the packets when UDP is used. These protocols are generally concerned with the host-to-host exchange of data.

The foregoing protocols are those that are typically used for internetworking generally. The other protocols illustrated have been developed specifically for providing multimedia services and IPtel services across the Internet, internetworks, or networks in general. Some of the protocols require the use of TCP/UDP while others are open as to the underlying protocols.

The Real-time Transport Protocol (RTP) is a protocol for real-time data, such as audio and video. This protocol is utilized for general multimedia services, in addition to the transport of IP telephony data. This protocol consists of a data part and a control part. The data part of RTP provides support for real-time properties such as timing reconstruction, loss detection, security, and content identification. The control part of RTP, known as the Real-time Control Protocol (RTCP) provides support for services such as source identification, quality of service feedback, as well as support for the synchronization of different media streams.

The Resource Reservation Protocol (RSVP) is a protocol that allows channels on the Internet to be reserved for the transmission of multimedia, such as video and other high-bandwidth data. Using RSVP, bandwidth can be reserved on the Internet to support this high bandwidth data, rather than relying upon the Internet's basic routing philosophy of “best effort,” which is generally inadequate for continuous streaming of video or audio programs.

The Real Time Streaming Protocol (RTSP) is an application-level protocol to control the delivery of data with real-time properties. This protocol is intended to control multiple data delivery sessions, provide a means for choosing delivery channels, and provide a means for choosing delivery mechanism based upon RTP.

As previously described, H.323 is a standard which provides for IP telephony signaling. While the H.323 standard provides recommendations for signaling, H.323 is an umbrella recommendation for providing multimedia communications over networks that do not provide Quality of Service (QoS). H.323 actually comprises several protocols used for different purposes but that work together. H.323 provides recommendations for compliant terminal units to utilize these protocols and defines four major components for a network-based communication system.

FIG. 2a illustrates an H.323 network-based communication system. The four major components for network-based communication defined by H.323 are terminals 200, 202, 204; gateways (not shown); gatekeepers 206 and multipoint control units (not shown). Terminals are client endpoints on the packet switched network that provide real-time, two way communications with other H.323 entities. H.323 terminals are required to support three functional parts: signaling and control, real-time communication, and codecs.

The terminal equipment supporting these functions is illustrated in FIG. 2b. For signaling and control 212, H.323 terminals must support the H.245 protocol 214, which is a standard for channel usage and capabilities, in addition to a Q.931-like protocol 216 defined in H.225.0 for call signaling and establishment. The terminal also supports a Registration/Administration/Status protocol 218 defined in H.225.0 for communication with gatekeepers 206. These protocols use ASN.1 encoding for their messages. For real time communication, H.323 terminals must support RTP/RTCP 226 for the sequencing of audio and video packets. Codecs 222, 224 are pieces of software that compress audio/video before transmission and decompress received audio/video. In order to maintain interoperability, H.323 terminals are required to support the G.711 audio codec. Video and other audio codecs are optional, however, if used must support a specified common mode of operation. In addition, H.323 terminals can support general data communications, using T.120. While outside of the scope of the recommendation, a H.323 terminal should support a LAN (network) interface.

While not shown, gateways in a H.323 network provide the same general services as gateways in other networks. Specifically, an H.323 gateway provides the connection between the packet-switched network and a Switch Circuit Network, such as the PSTN. Gateways perform setup and control on both the packet-switched network and the Switch Circuit Network, and act as an interface between the two to translate between transmission formats and procedures.

Also not shown are multipoint control units (MCU). MCUs support conferencing between three or more endpoints. The MCU provides control functions such as negotiation between terminals and determination of common capabilities for processing audio and video, in addition to the necessary processing on the media streams.

Gatekeepers 206 perform four required functions. The first of these is address translation from alias addresses or phone numbers to transport addresses. This provides the capability of terminal mobility. In addition, gatekeepers 206 provide support for admission control, bandwidth control and zone management. When a gatekeeper 206 is present, all other endpoints are required to register with gatekeeper 206 and receive its permission prior to making a call.

H.323 uses the concept of channels to structure the information exchange between communication entities. A channel is a transport-layer connection, which is either unidirectional or bi-directional. The II.323 standard defines four types of channels: RAS Channel, Call Signal Channel, H.245 Control Channel and Logic Channel for Media. The RAS Channel provides a means for communication between an endpoint and its gatekeeper. As previously described, this protocol is specified in H.225.0. Through the RAS Channel, an endpoint registers with its gatekeeper along with requesting permission to place a call to another endpoint. If permission is granted, the gatekeeper 206 returns the transport address for the call signal channel of the desired endpoint.

The call signal channel carries information for call control. The Q931-like protocol used for this channel is defined in H.225.0 and H.450.x. The H.245 Control Channel carries messages for media control with capability exchange support. The H.245 Control Channel is used for all call participants to exchange their capabilities, after which, Logical Channels for Media are opened through the H.245 Control Channel. Logical Channels for Media carry the audio, video and other data. Each media type is carried on a separate channel using RTP.

H.323 also provides for an inter-gatekeeper communication protocol for gatekeepers 206 in order to support terminal mobility when utilized in conjunction with the registration function. This means that a terminal device is capable of being moved from one network point to another, therefore acquiring a different transport address, however, a call can still be established using the higher abstract level alias address (E.164 or H323ID) or phone number. With the use of the registration services of the gatekeepers 206, the terminal device registers its transport address and alias address or telephone number so that its gatekeeper can perform the address translation. Through the use of the inter-gatekeeper communication protocol, when one endpoint seeks to establish a call with another endpoint using the alias address or phone number, an address can be located for an endpoint registered in a different zone or administrative domain.

Referring to FIG. 2a, terminal device 200 registers itself with its gatekeeper 206 and receives permission to make a call from gatekeeper 206 utilizing the RAS Channel. When the client receives permission and begins to make a connection, the alias of the called terminal device 204 is provided to gatekeeper 206. Terminal device 204 is located in a different domain, having its own gatekeeper (not shown) to which it is registered. Using its inter-gatekeeper communication protocol, gatekeeper 206 locates terminal device 204 and returns the endpoint's 204 transport address to terminal device 200, which then uses its Call Signal Channel, H.245 Control Channel and Logical Channel for Media to establish and conduct the call when in direct call mode. Alternatively, in a gatekeeper routed mode, instead of returning the transport address of terminal device 204, gatekeeper 206 instead routes the SETUP message to terminal device 204. Support is also being considered in the H.323 standard for personal mobility, i.e. the ability to reach a called party under a single, location-independent address even when the user changes terminals.

As previously mentioned, another multimedia communications protocol suite has been proposed by the IETF. In the IETF architecture, the media flows are performed utilizing RTP, as in H.323, and therefore, as previously described, the main difference is the signaling and control protocol. The SIP protocol is utilized in the IETF architecture for call signaling and control. SIP is an application layer protocol that can establish, modify and terminate multimedia sessions or calls.

FIG. 3a illustrates a SIP based communications network. The components for a SIP based network communication system are similar to those of H.323. These are terminal devices 300, 302, 304; proxy/redirectors 306; and registrars 308. As with H.323, terminals are client endpoints on the packet switched network that provide real-time, two way communications with other SIP entities.

FIG. 3b illustrates a typical SIP terminal device (endpoint). For performing system control/signaling a SIP endpoint comprises a user agent (UA) 312. The user agent comprises a user agent client (UAC) 314 and a user agent server (UAS) 316. UAC 314 is responsible for issuing SIP requests, and UAS 316 is responsible for responding to such requests. The rest of the terminal device supports similar capabilities as a H.323 terminal.

The proxy/redirectors 306 and registrar are known as network servers. Roughly these servers are analogous to a H.323 gatekeeper, while UA 312 is equivalent to the set of H.323 terminal system control protocols.

A typical SIP operation involves a SIP UAC issuing a request, a SIP server performing end user location and a SIP UAS accepting the call. SIP session establishment consists of two requests: an INVITE followed by an ACK. The INVITE message contains session description information that informs the called party what type of media the caller can accept and where it wishes the media data sent, while the ACK confirms session establishment.

Referring to FIG. 3a, when terminal device 300 wants to establish a call with terminal device 304, it sends an INVITE message to proxy/redirector 306 using UA 316. SIP user agents need to determine whether to use an outbound proxy and where to send registration updates. The address of the outbound proxy can be configured manually and the registration can be sent via multicast. DHCP is an additional method for configuring this information. DHCP is used extensively to configure boot-time information in IP-connected hosts. For more sophisticated selection of proxies, the IETF Server Location Protocol (SLP) allows proxies and registrars to advertise their capabilities. In large networks, users may have a choice about the SIP server they connect to. Different servers can provide different services to their users; for example, some may support CPL execution, and others may not. Some may support IPSec, and some may not. SLP, specified in RFC 2608, defines a way in which SIP end systems can discover SIP servers providing specific capabilities.

In any case, when proxy/redirector 306 receives the INVITE message, it communicates with a registrar/location server 308 to retrieve the location (transport address) corresponding to the SIP-URL used to indicate the callee. Typically, registration is performed by a terminal device upon startup utilizing a REGISTER message. When acting as a proxy, server 306 establishes the call by sending an INVITE to terminal device 304 and continues to act as a go-between for the endpoints during the session. When acting as a redirector, server 306 returns the address of terminal device 304 to terminal device 300, which then establishes the session directly with terminal device 304. It should be noted that, while illustrated as two different machines, often times registrar 308 and proxy/redirector 306 are implemented on the same machine. Also, through the use of the registration server, SIP provides for terminal mobility, in addition to personal mobility.

The session multimedia description information within a SIP request and response message, as well as announcements for a session are provided for using the IETF Session Description Protocol (SDP) 318. This protocol is generally the equivalent of H.245 in the H.323 standard.

The Media Gateway Control Protocol, developed by Telcordia and Level 3 Communications, is one of a few proposed control and signal standards to compete with the older H.323 standard for the conversion of audio signals carried on telephone circuits (PSTN ) to data packets carried over the Internet or other packet networks. The reason new standards are being developed is because of the growing popularity of Voice over IP (VoIP ). MGCP and Megaco/H.248 are media gateway control protocols defined by the IETF and ITU-T for use in distributed switching environments. Referring to FIG. 3c, signaling logic is located on Media Gateway Controllers 330 (MGCs-also known as Call Agents or SoftSwitches) and media logic is located on Media Gateways 332 (MGs). Using MGCP or Megaco/H.248 334, MGCs can control MGs to set up media (for example, voice traffic) paths 336 through the distributed network. Regular phones are relatively inexpensive because they don't need to be complex; they are fixed to a specific switch at a central switching location. IP phones and devices, on the other hand, are not fixed to a specific switch, so they must contain processors that enable them to function and be intelligent on their own, independent from a central switching location. This makes the terminal (phone or device) more complex, and therefore, more expensive. The MGCP is meant to simplify standards for this new technology by eliminating the need for complex, processor-intense IP telephony devices, thus simplifying and lowering the cost of these terminals.

The following references describe other IP telephony systems or packet based communication systems:

The patent to Rondeau et al. (5,796,728), assigned to Ericsson Inc., provides for a Communication System and Method for Modifying a Remote Radio Using an Internet Address. The patent describes a two-way multi-user radio communication system. Additional devices attached to the radio include GPS-based automatic vehicle locator, mobile data terminal (e.g., bar code reader), printer and/or a video apparatus. Each of the devices is assigned a different IP address and can independently, but not simultaneously, send/receive data packets to/from the host computer. However, the host computer does not perform any processing to establish calls between radio units and other end devices. In addition, as previously described, it is not contemplated by Rondeau that the attached devices could transmit data simultaneously and therefore it is not contemplated to allow the devices to act as general, simultaneous input/output devices for control of the host computer.

The patent to Mashinsky (6,005,926) assigned to ANIP, Inc., provides for a Method and System for Global Communications Network Management. The patent teaches a system and method for flexible and efficient routing of communications transmissions. It further states that a global network may embrace all classes of connectivity, including VoIP networks.

The patent to Arango et al. (WO 99/28827) provides for a Method and System for Media Connectivity over a Packet-based Network. The patent discloses a method and system for a distributed, scalable, hardware independent system that supports communication over a packet-based network. The communications include VoIP, video conferencing, data transfer, telephony, and downloading video or other data. The media control devices uses Real Time Protocol (RTP) to communicate over an IP network. A central call agent that translates from a fully implemented protocol in a terminal device, such as H.323, to a second fully implemented protocol, provides the hardware independence.

The patent to Lee et al. (EP 0 964 567) provides for a Programmable Telecommunications Interface for Communication over a Data Network. The patent describes a multimedia communications protocol for multimedia applications such as video conferencing, Internet telephony, and VoIP.

NATs and Firewalls present a challenge to a network software programming, while their functions and operations are different: firewalls filter information into and out of the private network, while NATs hide or encapsulate a private network behind a single of few “real” Internet Protocol addresses. NAT, short for Network Address Translation, an Internet standard that enables a local-area network (LAN) to use one set of IP addresses for internal traffic and a second set of addresses for external traffic. A NAT box located where the LAN meets the Internet makes all necessary IP address translations. NAT serves two main purposes:

Provides a type of firewall by hiding internal IP addresses

Enables a company to use more internal IP addresses. Since they're used internally only, there's no possibility of conflict with IP addresses used by other companies and organizations. This allows a company to combine multiple ISDN connections into a single Internet connection.

Their Effect on Many Network Applications is the Same:

The inability to send and receive information when receiving information using UDP (e.g., UDP data-grams coming into the private network).

The inability to send and receive information when opening TCP communications into the private network.

Each of the Below Described References Teach the Method of Firewalls in General.

U.S. Pat. No. 5,898,830, assigned to Network Engineering Software describes a system, which allows connectionless traffic across a firewall. Rule checking is performed on the first packet entering, and if it is determined that the packet needs to be sent, a virtual host sends it to the destination computer. A time limit is set and so long as the set time limit does not run out, the communication is allowed. Addressing is accomplished utilizing name based addressing for end-to-end communication, with virtual hosts/DNS servers providing the intermediate address routing information. A connection type session does not appear to be initiated for the UDP transport.

U.S. Pat. No. 5,915,087 discloses a firewall system, which allows communication, using a connectionless protocol. The firewall holds a list of servers located on the private side, and intercepts any communications addressed to the servers. The firewall then binds a port and notes it in a link table. The packet is passed to a stack, on the private side, which forwards the packet to the server. Any communications from the server to the originating client is sent to the firewall, where the originating clients address is determined using the link table.

U.S. Pat. No. 5,778,174 describes a system, which utilizes an external machine, located on a public network to bypass a router firewall. A client on the public network connects to the external machine. A private channel is opened between the external machine and a machine internal to the private network. The internal machine connects to the destination server, and communication between the client and server is conducted through the external and internal machines.

U.S. Pat. No. 5,941,988 provides for a proxy system that “glues” together two separate TCP connections terminating at a common host (proxy). When communications from one connection are received at the proxy, the headers are altered to address the socket at the end of the second connection, and the sequence numbers of the first connection are mapped to the sequence space of the second connection.

The non-patent literature entitled, “A Weakness in the 4.2BSD Unix TCP/IP Software” describes the spoofing of a trusted host to communicate with a system, having a list of the trusted hosts, from a host that is not on the trusted list.

HTTP, an abbreviation for HyperText Transfer Protocol, represents the underlying protocol used by the World Wide Web. HTTP defines how messages are formatted and transmitted, and what actions Web servers and browsers should take in response to various commands. For example, when entering an URL in a browser, this action sends an HTTP command to the Web server directing it to fetch and transmit the requested Web page. The other main standard that controls how the World Wide Web works is HTML, which covers how Web pages are formatted and displayed.

HTTP has, among other features, the ability to penetrate firewalls. HTTP is called a stateless protocol because each command is executed independently, without any knowledge of the commands that came before it. Currently, most Web browsers and servers support HTTP 1.1. One of the main features of HTTP 1.1 is that it supports persistent connections. This means that once a browser connects to a Web server, it can receive multiple files through the same connection.

What is needed, and the prior art has failed to provide, is a communication protocol that incorporates the benefits of VoIP (IPL6), H.323 and HTTP/TCP such to enable a robust communication protocol with messaging, call functions, personalized communication policies and address book capabilities. While the benefits of H.323 and SIP are known, H.323, by itself, cannot penetrate firewalls; SIP, by itself, cannot provide the messaging functions.

Whatever the precise merits, features and advantages of the above cited references, none of them achieve or fulfills the purposes of the present invention.

### SUMMARY OF THE INVENTION

A transactional protocol enabling messaging, call functions, presence, personalized communication policies and address book capabilities. The protocol is used between subscriber clients (windows specific or otherwise) and a server-based communication system. At the lowest level, the protocol uses HTTP 1.0 (and optionally HTTP 1.1) as a transport, and a combination of a special URL format and content-information to describe intent and results. Transactions comprise families of verb sets, each verb set built using a combination of generic verb headers and device/server/session specific tags.

The present invention protocol is transactional in nature. That is to say that the client (in the client-server relationship, not necessarily a subscriber client) sends a request, and the server (again, not necessarily a subscriber server) replies. Generally, a client generates a verb, sends it to the server, and an appropriate handler is found on the server to take action accordingly. The verb must contain all the information that is required for the server to take action, or a reject will be returned.

While the preferred embodiment of the present invention protocol uses HTTP as a transport layer, alternate transports such as UDP, TCP, SSL, IPSEC, TLS can be substituted therefore without modification. One assumption the protocol makes is that transactions are never lost. The protocol, due to its transactional nature, does not required messages to be sent or arrive in order.

### BRIEF DESCRIPTION OF THE DRAWINGS

FIG. 1 illustrates the protocols for transmitting multimedia and performing IP telephony across an IP-based network.

FIG. 2a illustrates an H.323 network-based communication system.

FIG. 2b illustrates a typical terminal device for a H.323 network.

FIG. 3a illustrates a SIP based communications network.

FIG. 3b illustrates a typical terminal device for a SIP network.

FIG. 3c illustrates a MGCP or H.248/Megaco based communications network.

FIG. 4 illustrates a basic system diagram of the present invention.

FIG. 5 illustrates a basic system diagram of the present invention with verb patterns.

FIG. 6 illustrates a block diagram of the present invention protocol families.

FIGS. 7a-7e collectively illustrate generic verb fixed field sets.

FIGS. 8a-8f collectively illustrate presence verbs field sets.

FIGS. 8g-10c collectively illustrate calling verb field sets.

FIGS. 11a-12e collectively illustrate buddy list verb field sets.

FIGS. 12f-14b collectively illustrate message verb field sets.

FIGS. 14c-14e collectively illustrate policy verb field sets.

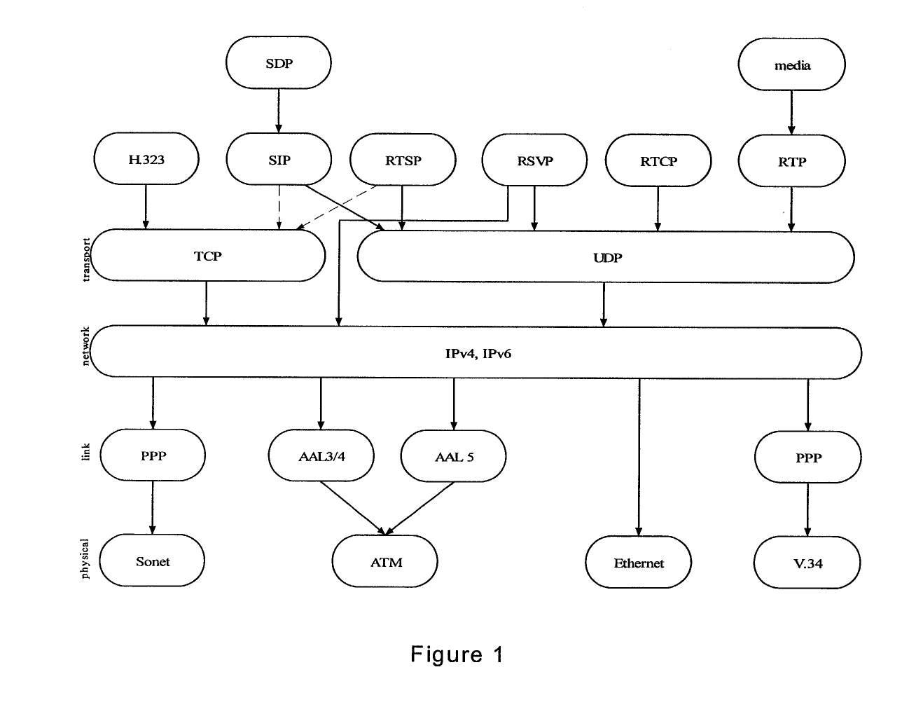

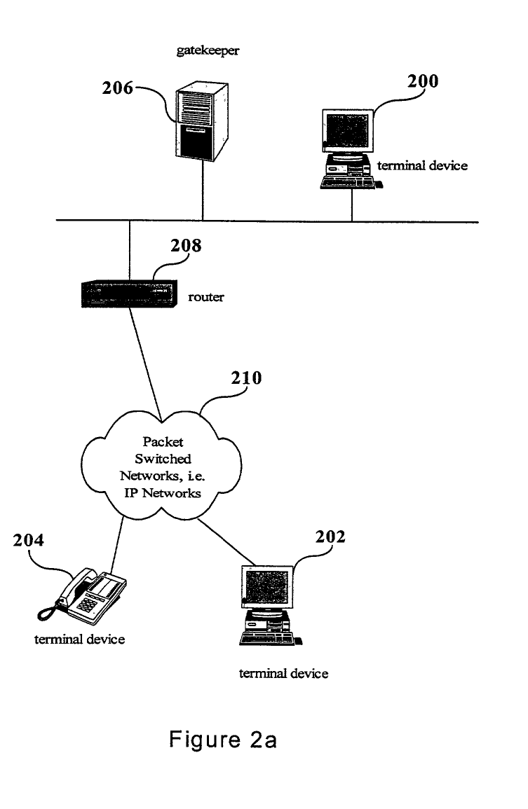

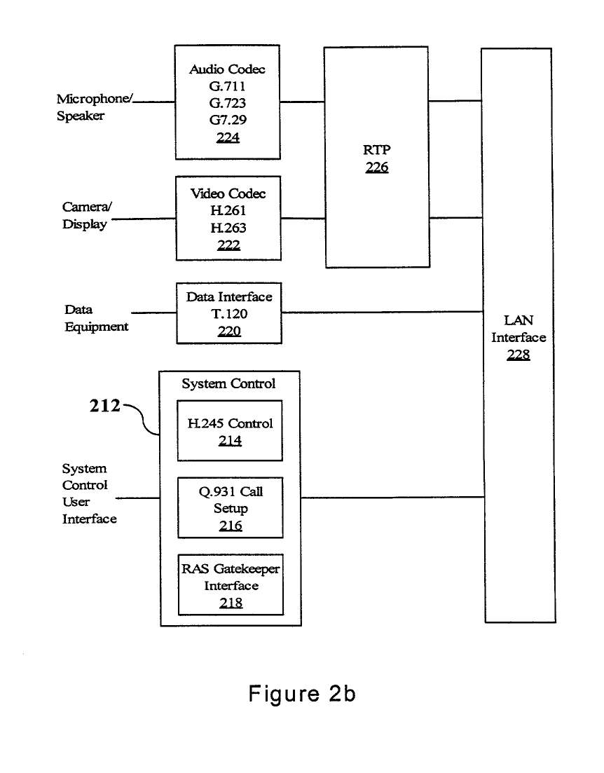

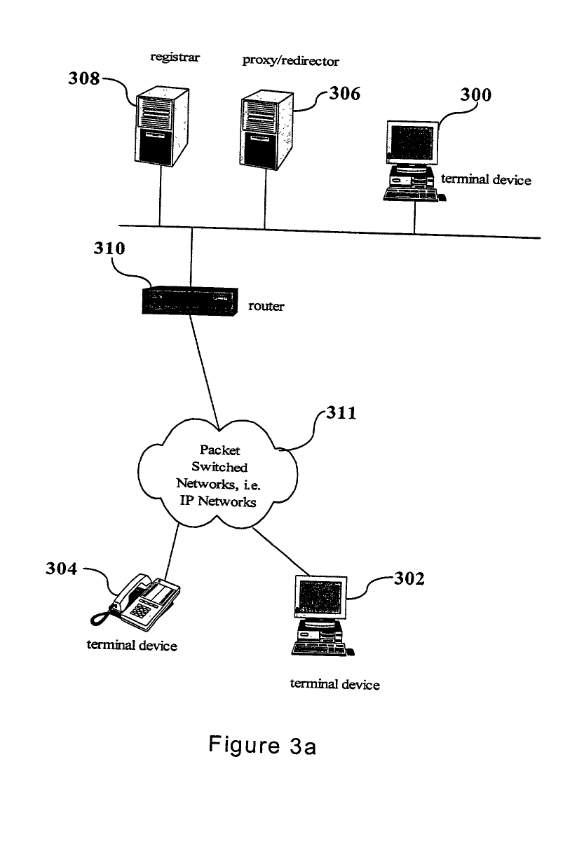

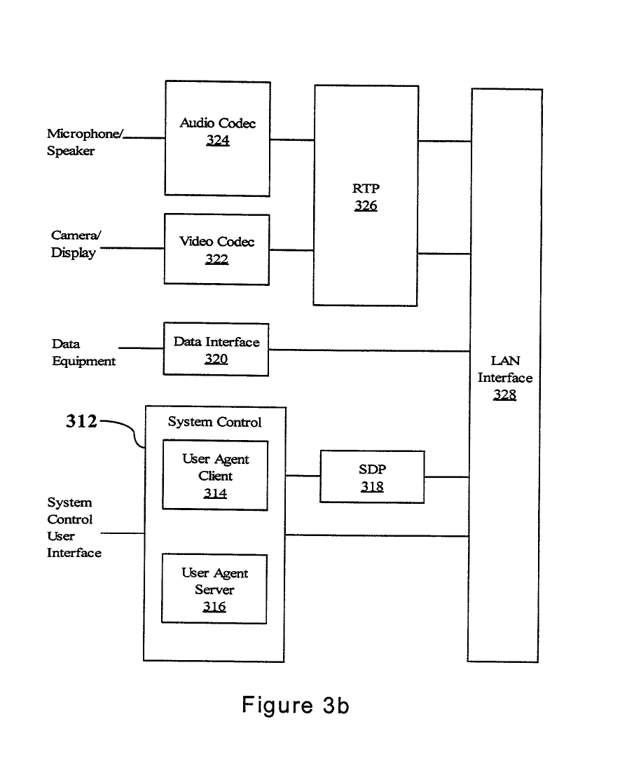

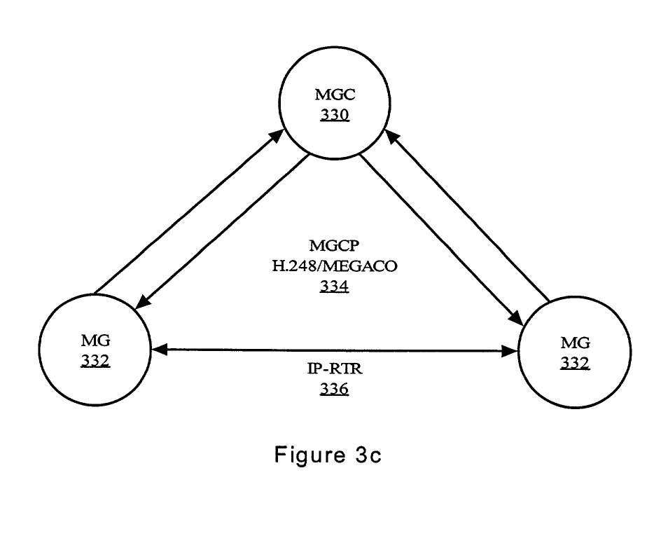

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. Throughout the specification and drawings references to TG and TrulyGlobal™ and variations thereof refer to a commercially available server based subscriber service implementing the preferred embodiment of the present invention. Any functionally equivalent server based subscriber service can be substituted without departing from the scope of the present invention.

The preferred embodiment describes five verb families, however, other verbs can be added to the verbs sets described, verb extensions added or new verb families added (e.g., customer specific, industry specific, industry standards, proprietary, encrypted or XML, etc.) without departing from the scope of the present invention or compromising backward compatibility or interoperability.

The preferred embodiment has been shown using the classic client server model, however, the protocol is equally applicable to other communications models, e.g. server-server, client-proxy server-server, client-server-proxy server.

The described embodiments include a general discussion of policies (including routing policies), however, a full description of exemplary policy parameters may be found in co-pending U.S. patent application. Ser. No. 08/780,739, hereby incorporated by reference.

While the use of TCP in HTTP presents some performance challenges to the design of an interactive service such as TG, the advantages far outweigh the performance issues. The fact that HTTP/TCP combination is so commonly used also insures the OS and network equipment manufacturers will concentrate optimization efforts in this area.

HTTP is used as a transport for the following reasons (not exhaustive listing):

Firewall & NAT transparency

HTTP proxy transparency

Ease & availability of implementations

Ease of debugging-which effects the speed at which new services can be developed, debugged, integrated, and deployed

Ability to base services on off-the-shelf application solutions (e.g., HTTP servers and Web Application Servers)

Ability to use HTTP security, including SSL/TLS for transport level encryption and authentication

Ability to use off-the-shelf web-cluster, web-high availability and fail over technologies

Ability to support communi9cations over UDP.

The preferred embodiment uses the novel protocol in PC-to-PC Internet telephony, based on the technologies in Internet Phone Lite 6 (IPL6). To insure that the absolute minimum is changed in IPL6, H.323 (specifically H.225.0 FastStart) will be used for signaling. The only internal change in the client will be the support of this protocol.

The design of the protocol was also influenced by the requirement to implement clients using Web-Technologies, such as JavaScript. The protocol is easy to implement, and presents few technical challenges to developers.

FIG. 4 illustrates an overview of an Internet connected client/server implementation of the present invention. Client 402 uses various VoIP enabled Internet devices, for example a PC with browser, a WAP (wireless access protocol) telephone, or a web telephone. The client (in the client-server relationship, not necessarily a subscriber client) sends a request, and the server (again, not necessarily a subscriber server) replies. A firewall, in some scenarios exists between the client and server, and is penetrated by the present invention HTTP based protocol.

Generally, a client generates a verb, sends it to the server, and an appropriate handler is found on the server to take action accordingly. The verb must contain all the information that is required for the server to take action, or a reject will be returned. The server, in the preferred embodiment, is connected to various server based subscriber services and can therefore perform a multitude of functions using the single present invention protocol. As shown the services include, but are not limited to, policy, presence, messages, calling functions and address book (including “buddy lists”).

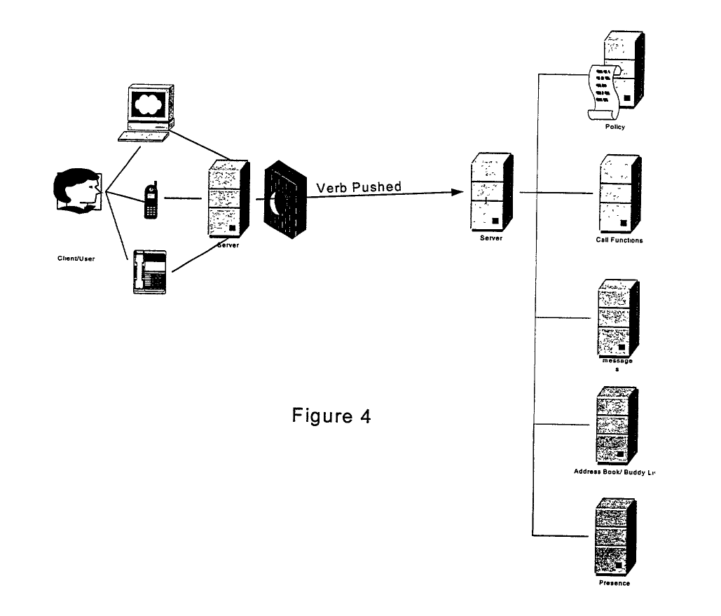

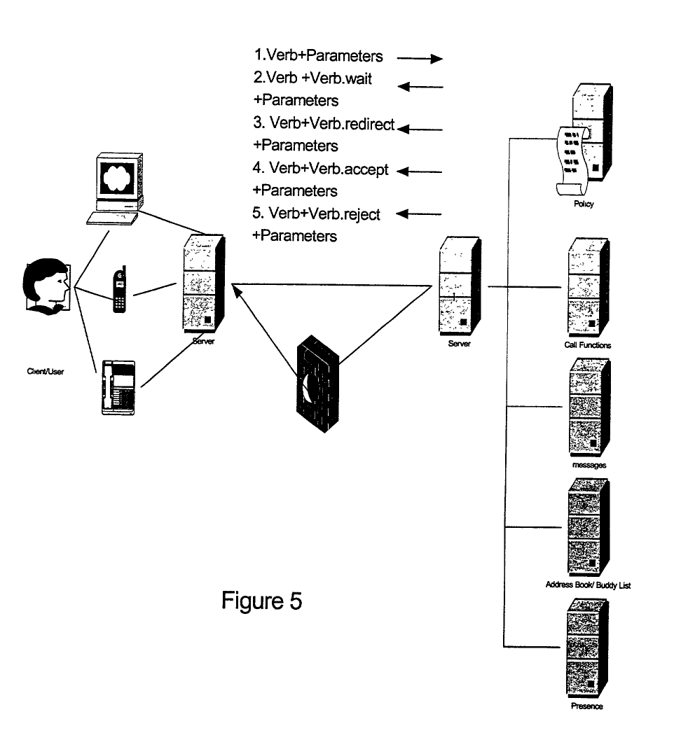

FIG. 5 illustrates the system of FIG. 4 with the verb transaction patterns. The present invention protocol transactions follow the verb → wait/accept/redirect/reject pattern.

| Primitive | What it Means |
|---|---|
| Verb | A request. Basically a request to change some state in the |
| | server, or to search for some information that is available |
| | to the server directly or indirectly, or to take some action on |
| | behalf of the client. |
| Verb.wait | The server has received the verb, and is taking some action. |
| | The client is requested to wait for a reply by resetting its |
| | reply time-out timer. |
| Verb.redirect | The server requests that the original verb be sent to another |
| | server, and has not changed any internal state. |
| Verb.accept | The server has accepted the request. |
| Verb.reject | The server has rejected the request, |
| | and has not changed any internal state. |

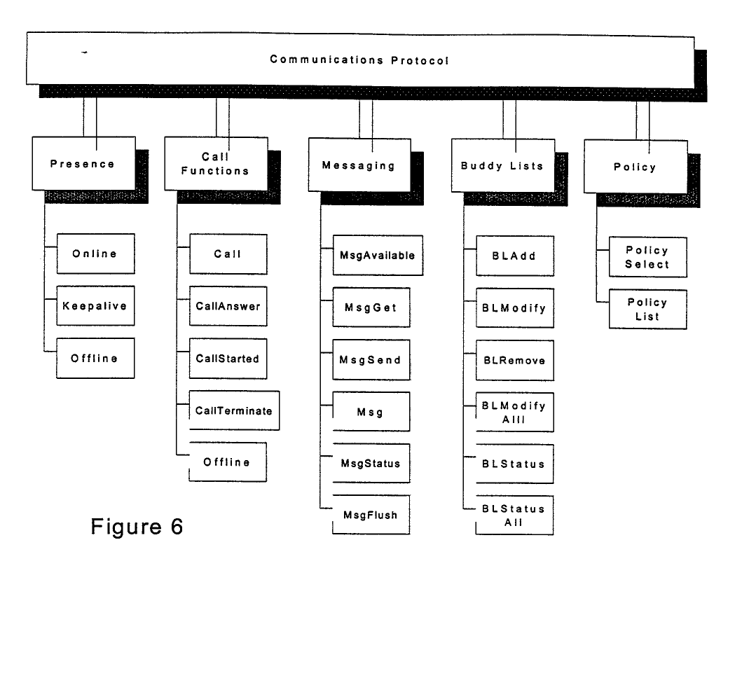

FIG. 6 illustrates the preferred embodiment verb Families. The present invention protocol transactions are separated into families. A subscriber service protocol server must support all verb families, while a protocol client must support only the Presence set. The server must not send a transaction to a client that does not support the family the transaction is in. Families are identified by a single letter ID.

| Family | What it Means | ID |
|---|---|---|
| Presence | Provides the facility for the client to inform the server | P |
| | that it is available and can terminate and/or originate | |
| | services. | |
| Calls | Provides facilities for client to locate other users and get | C |
| | permission to call these users, and for called users to get | |
| | permission from the server to answer an incoming call. | |
| BuddyList | Provides facilities to Change and Get updates as to the | B |
| | subscribers Address Book state. | |
| Messaging | Provides facilities to manage text messaging between the | M |
| | client and the server, and other clients. | |
| Policy | Provides facilities to the server to send the list of | Y |
| | available policies to the client and the “active” policy, | |
| | and for the client to designate a different “active” policy. | |

Basic Syntax

This section describes the basic taxonomy the protocol uses to present information and issues (such as transaction failures) to the using application.

Basic Elements

The present invention protocol uses the following basic types to describe Information Elements:

| Basic | | |
|---|---|---|
| Element: | Details: | Example: |
| Boolean | 0 or 1 | 1 |
| | | 0 |
| Float | A floating point number | 543.65 |
| Integer | A 32 bit integer number. | 512 |
| Integer64 | A 64 bit integer number. | 512ˆ 512ˆ 512 |
| String | A sequence of characters. The sequence must | Alex |
| | not include the special “\|”,“,”,“[”,“]”,“(”,“)”, | [4]Alex |
| | or “=” characters unless prefixed with a | |
| | length indicator. Length Indicators are build | |
| | from a “[”, a number (describing the | |
| | number of characters the follow), a closing | |
| | “]”, and the String characters. | |
| UTF8 | A sequence of characters encoded using | |
| | the UTF-8 format. The sequence must not | |
| | include the special “\|”,“,”,“[”,“]”, or | |
| | “=” characters unless prefixed with a length | |
| | indicator as described for String. | |
| Null | A special identifier used when an optional | * |
| | parameter is not provided. | |

Compound Types and Nesting

Besides the basic types, a protocol element (or field) can be in one of the following compound types:

| Type | Encoding |
|---|---|
| Simple values | One of the above basic elements. A sequence of |
| | characters, with possible [length] prefix, if it contains |
| | a “special” character. |
| Array type | is a sequence of values, separated by commas, and |
| | surrounded by “{” and “}”. |
| | NOTE: an array of a single element MAY be encoded as |
| | a simple type (without the surrounding brackets) |
| Sequence type | a sequence of “name=value” pairs. The sequences are |
| | separated by comma, and surrounded by “(” and “)” |

Complex Elements

The present invention protocol uses the following information elements to assemble transaction messages:

| | Basic | |
|---|---|---|
| Element: | Type | Details & Example: |
| Address | String | (IP address OR DNS name) + “:” + Port |
| | | Used to describe an IP address or a DNS |
| | | name that can be resolved into an IP |
| | | address. May include a port element. |
| | | For example: |
| | | 199.203.72.1:1720 |
| | | www.trulyglobal.com:80 |
| Alias | String | UTF8 + @ + UTF8 |
| | | An alias is used to identify a user within and |
| | | a service. For example ost@e164.tg.com |
| | | may describe user |
| | | Ost at a service e164.tg.com. Aliases must |
| | | use a unique name-space after the |
| | | @ (e.g. e164.tg.com must be |
| | | a unique name-space identifier). |
| | | For example: |
| | | gur@email.tg.com |
| | | 0012012287016@e164.tg.com |
| Codec | String | Used to describe the media capabilities of a |
| | | client. These codes are used to describe |
| | | capabilities for multimedia sessions. |
| | | For example: |
| | | Audio/VHQC.64 |
| | | Video/H.263+ |
| DeviceInfo | Sequence | These parameters must include at least the |
| | | device-name, followed by a “(”, OS=, |
| | | Version=, and Build= values, optional |
| | | other values, and a closing “)”. |
| | | For example: |
| | | TGClient(OS=WinNT4/SP5,Ver=6.11, |
| | | Build=1832,Lang=EN) |
| TransactionID | String | A 64 bit sequence number (growing |
| | | monotonically and created by the client) |
| | | followed by a “:” followed by a TTL |
| | | value. The TTL value must be reduced by |
| | | 1 for every redirecting or waiting element. |
| | | If TTL = 0 the transaction must be |
| | | aborted and a Verb.reject(0.0.6) must be |
| | | returned. |
| | | For example: |
| | | 54730:12 |
| Mimetype | String | A string containing a mime-type |
| MOS | Float | A Mean-Opinion-Score value describing the |
| | | quality of audio communications. This value |
| | | is transmitted in the CDR |
| | | (call-details-record) transaction. |
| Period | Integer | A number in seconds that describes a period |
| | | of time. |
| Reason | String | Used to describe errors and problems. |
| | | Specific reason-codes and when they are |
| | | generated are detailed later in the |
| | | specification |
| Token | String | An opaque data element. Tokens are usually |
| | | associated with the transaction that follows |
| | | the verb reply, e.g. if a Token is received |
| | | in a Call.accept reply, the token must be |
| | | placed in the appropriate place in the native |
| | | signaling protocol used to set-up the call. |
| URL | String | Specific example URLs are described |
| | | hereafter. |

Call-ID Encoding/Decoding

The CallID parameter when calling is packed into a 16 byte value (as per H.323) using Hex2Bin, and upon reception is unpacked using Bin2Hex.

H.323 Tokens Encoding/Decoding

H.323 Tokens are binary, and therefore is converted from and to a textual representation using the UUEncode method.

URLs:

The address portion may be replaced with a “*”, which must be interpreted as the address of the device that sent the message, as provided by the transport layer, when applicable. URLs are described in detail in IETF RFC 2396.

| URL | What it Means |
|---|---|
| h323 : address : port : e164.to=+9729970804 : | Used to identify a |
| e164.from=+97299704564 | device that can |
| | originate or terminate |
| | ITU-T H.323 calls. |
| v2.h323 : address : port : e164.to=+9729970804: | Used to identify a |
| e164.from=+97299704564 | device that can |
| | originate or terminate |
| | LTU-T H.323 version |
| | 2 calls. The e164 |
| | parameters are used |
| | for PSTN (e.g. |
| | Gateway) calls. |
| im.tgp : TGID | Used to identify |
| | a TG subscriber for |
| | sending instant |
| | messages. |
| sip : address : port : | Used to identify a |
| e164.to=+9729970804:e164.from=+97299704564 | device that can |
| | originate or terminate |
| | IETF SIP calls. |
| mailto : user@domain.com | Used to identity an |
| | email recipient. |
| http://domain.com/directory | Used to identify a |
| | web page. |

Tokens

Quality of Service (QoS) Token

A QoS token defines the requested or reported quality level for one side of a real-time communication session. It is build from a set of codecs (for video and audio), packet-loss values, jitter values, delay (one-way) values, and MOS (mean [audio] opinion score) value. Some parameters also contain the STD value for the sample-period (the standard deviation). The unique identifier “QoS” must be used to identify the QoS token, and is prefixed to every

QoS Token.

The QoS Token is encoded in plain text, and is built as a standard TGP array from the following elements. The Tag is not included in the encoding, but is provided so it may be used in a present invention protocol API. Any element may be skipped (e.g., replaced with an empty element) which means that the value is not important, or is not available. QoS values are averaged, e.g. if 1 minute of a call is reported, the average values for that minute are provided (not the best or the worst).

| Type | Tag | Details |
|---|---|---|
| Codec | Codec | As defined in Annex A. |
| Integer | Frames | Frames per-packet. |
| Float | PacketLoss/STD | A value between 0 and 100 |
| Float | MOSs | A value between 0 and 5. |
| Integer | Delay/STD | A value in milliseconds. |
| Integer | Jitter/STD | A value in milliseconds. |
| Integer | PHB | Per Hop Behavior value as defined in |
| | | IETF DiffServ used to color the audio |
| | | packets. |
| Codec | VideoCodec | As defined in later in the specification. |
| Float | VideoRate/STD | A Value between 0 and 30 - number of |
| | | frames per second. |
| Integer | VideoPacketLoss/STD | |
| Float | VideoMOS | Quality of Video image - using the |
| | | verbiage of audio MOS (a value |
| | | between 0 and 5). |
| Integer | VideoSizeH | Horizontal resolution of video |
| Integer | VideoSizeV | Vertical resolution of video |
| Integer | VideoPHB | Per Hop Behavior value as defined in |
| | | IETF DiffServ used to color the audio |
| | | packets. |

Transactions

This section abstractly describes each present invention protocol transaction, whether it is mandatory, who can originate it, and what mandatory and optional elements it may contain.

Origination

Further following FIG. 6 and the following table of a summary of what element (e.g. the TG client or the TG server) originates which transaction:

| Family/Transaction | Client→Server | Server→Client |
|---|---|---|
| Presence: | | |
| Online | Yes | No |
| KeepAlive | Yes | No |
| Offline | Yes | Yes |
| Calls: | | |
| Call | Yes | No |
| CallAnswer | Yes | No |
| CallStarted | Yes | No |
| CallTerminate | No | Yes |
| CallEnded | Yes | No |
| Buddy List: | | |
| BLAdd | Yes | Yes |
| BLModify | Yes | Yes |
| BLRemove | Yes | Yes |
| BLModifyAll | Yes | Yes |
| BLStatus | No | Yes |
| BLStatusAll | No | Yes |
| Messaging: | | |
| MsgAvailable | No | Yes |
| MsgGet | Yes | No |
| MsgSend | Yes | No |
| Msg | Yes | Yes |
| MsgStatus | Yes | Yes |
| MsgFlush | No | Yes |
| Policy: | | |
| PolicySelect | Yes | Yes |
| PolicyList | No | Yes |

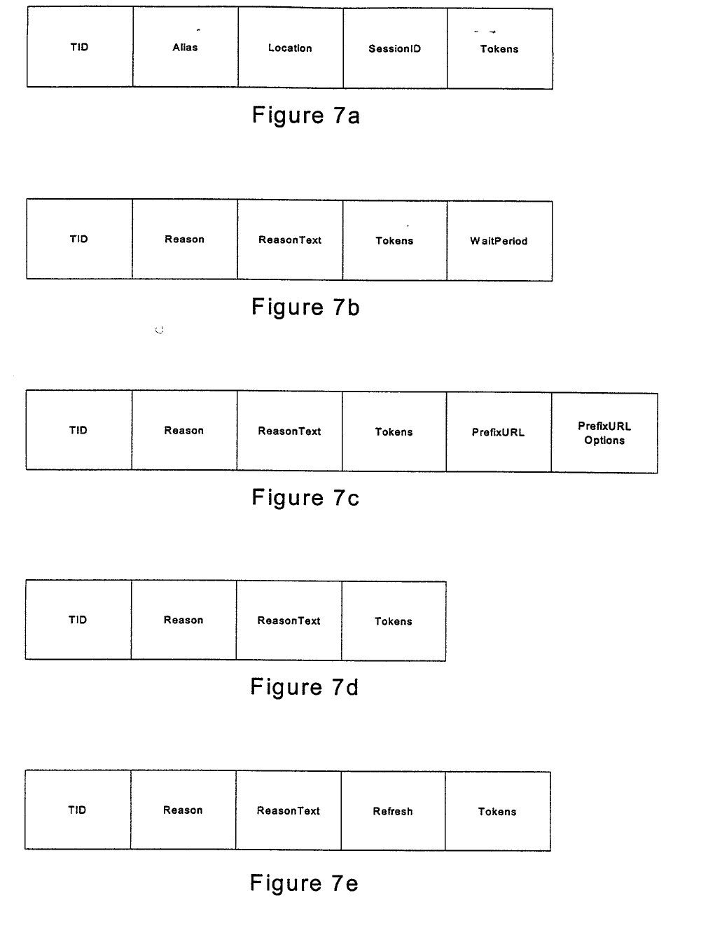

Generic Verb Header Fields-FIG. 7a

Every present invention protocol transaction verb begins with a fixed set of fields, followed by fields that are specific to that transaction.

| # | M O | Type | Tag | Details |
|---|---|---|---|---|
| 1 | X - | TransactionID | TID | The transaction ID that uniquely identifies |
| | | | | this transaction and generated for this verb. |
| 2 | X - | Alias | Alias | The alias of the device that is sending the |
| | | | | Verb. |
| 3 | X - | UTF8 | Location | The location of the Alias, e.g. home, work, |
| | | | | laptop etc. |
| 4 | - X | String | SessionID | A session identifier provided by the server |
| | | | | when the client becomes online for the first |
| | | | | time. Once provided by the server, the |
| | | | | client must use this identifier in all future |
| | | | | communications with the server. |
| 5 | - X | Token [1..n] | Tokens | Opaque data elements that the client may |
| | | | | not understand. |

Generic Verb.wait, Verb.redirect, and Verb.reject replies

Unless mentioned otherwise for a specific transaction, the wait, redirect and reject transaction replies must follow the following format, regardless of what verb is used:

Verb.Wait-FIG. 7b

| # | M O | Type | Tag | Details |
|---|---|---|---|---|
| 1 | X - | TransactionID | TID | The transaction ID that uniquely identifies |
| | | | | this transaction as provided in the original |
| | | | | verb. |
| 2 | - X | Reason | Reason | The reason this transaction is taking longer |
| | | | | then anticipated. |
| 3 | - X | UTF8 | ReasonText | Human readable reason text. |
| 4 | - X | Token | Tokens | Opaque data elements that the client may |
| | | [1..n] | | not understand. |
| 5 | X - | Period | WaitPeriod | How much time in seconds the client should |
| | | | | wait until the server sends the next reply |

M: Mandatory
O: Optional

Verb.Redirect-FIG. 7c

| # | M O | Type | Tag | Details |
|---|---|---|---|---|
| 1 | X - | TransactionID | TID | The transaction ID that uniquely identifies |
| | | | | this transaction as provided in the original |
| | | | | verb. |
| 2 | - X | Reason | Reason | The reason this transaction is being |
| | | | | redirected. |
| 3 | - X | UTF8 | ReasonText | Human readable reason text. |
| 4 | - X | Token | Tokens | Opaque data elements that the client may |
| | | [1..n] | | not understand. The client must provide |
| | | | | these tokens to the server that it is being |
| | | | | redirected to. |
| 5 | X - | URL | PrefixURL | Alternate hosts that must be used to send |
| | | [1..n] | | this transaction to. If more then one |
| | | | | alternate is provided, they must be |
| | | | | contacted one by one in the order |
| | | | | provided until a legal reply is returned. |
| | | | | The original transaction (e.g., |
| | | | | /tgp/v1/Verb()) must be prefixed with the |
| | | | | provided URL. |
| 6 | - X | String | PrefixURLOptions | Options for each URL. Options are |
| | | [1..n] | | formatted as Tag + “=” + Option + “/” + |
| | | | | Option. Options are separated using the |
| | | | | “,” character. The complete Options |
| | | | | element must be length-encoded. There |
| | | | | must be as many option elements as there |
| | | | | are PrefixURL elements. |
| | | | | Supported options are: |
| | | | | Token = 1/2/3,Token = 2/3 |
| | | | | Which tokens are associated with every |
| | | | | URL (by Token index location). In this |
| | | | | example the first 3 tokens provided in the |
| | | | | transaction are associated with the first |
| | | | | PrefixURL, while the second PrefixURL |
| | | | | is associated with the 2^{nd} and 3d Tokens. |

M: Mandatory
O: Optional

Verb.Reject-FIG. 7d

| # | M O | Type | Tag | Details |
|---|---|---|---|---|
| 1 | X - | TransactionID | TID | The transaction ID that uniquely identifies |
| | | | | this transaction as provided in the original |
| | | | | verb. |
| 2 | X - | Reason | Reason | The reason this transaction is being |
| | | | | redirected. |
| 3 | - X | UTF8 | ReasonText | Human readable reason text. |
| 4 | - X | Token | Tokens | Opaque data elements that the client may |
| | | [1..n] | | not understand. |

M: Mandatory
OK Optional

Verb.Accept Header Fields-FIG. 7e

Every present invention protocol Verb.accept reply begins with a fixed set of fields, followed by fields that are specific to that accept reply.

| # | M O | Type | Tag | Details |
|---|---|---|---|---|
| 1 | X - | TransactionID | TID | The transaction ID that uniquely identifies |
| | | | | this transaction as provided in the original |
| | | | | verb. |
| 2 | - X | Reason | Reason | The reason this transaction is being |
| | | | | accepted. |
| 3 | - X | String | ReasonText | Human readable reason text. |
| 4 | - X | Integer | Refresh | How much time in seconds the client |
| | | | | should wait between KeepAlive refreshes: |
| | | | | Period * (0.5 + rand()) |
| 5 | - X | Token | Tokens | Opaque data elements that the client may |
| | | [1..n] | | not understand. |

Presence Transactions

provides a service to TG clients where they can (a) inform the server that they are available to originate and/or terminating some service, and (b) inform the service when the terminal is going off-line, and will no longer be able to originate and/or terminate services.

Security

The client must use the procedures described hereafter in reference to security to generate a session key during the Online/Online.accept sequence. The client must use the provided SessionID value in all subsequent transactions, and generate a valid Message Authentication Token (MAT) for every transaction but the Online transaction.

Online

clients inform the server that they are on-line and available by using the Online transaction. This transaction is functionally equivalent to ITU-T H.225.0 RAS RRQ/RCF/RRJ sequence and to IETF RFC 2543 REGISTER procedure.

The SessionID parameter provided in the Online verb is the session ID from the last session, if known. If not known then an empty string must be provided.

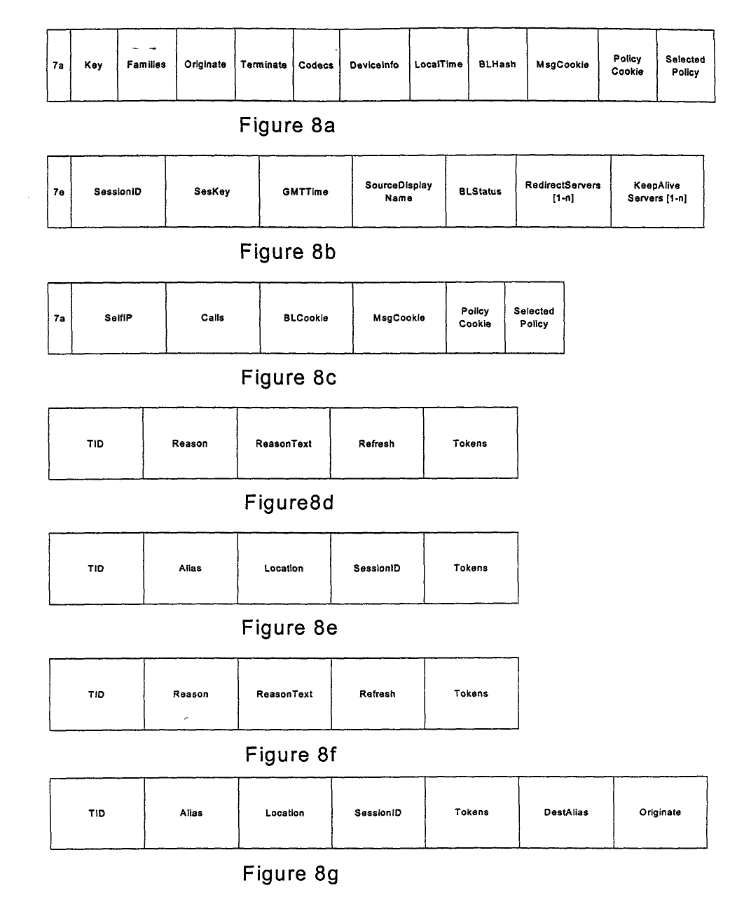

Online Verb-FIG. 8a

| # | M O | Type | Tag | Details |
|---|---|---|---|---|
| 1.. | Parameters as defined in Generic Verb section - Figure 7a | | | |
| 5 | | | | |
| 6 | X - | String | Key | The Key contains the prefix |
| | | | | “spass:xx/Hash” where xx is a random |
| | | | | string and Hash is the md5 hash of the “xx” |
| | | | | string concatenated by the password ( |
| | | | | md5(xx pass)). |
| 7 | X - | String | Families | What present invention protocol transaction |
| | | | | families are supported by this device? A |
| | | | | sequence of one of P, B, C and M (as |
| | | | | defined above). |
| | | | | For example, if the client supports presence |
| | | | | (it must), messages and placing calls, but |
| | | | | not buddy-list transactions, it must place |
| | | | | “PCM” in the Transaction-Families field. |
| 8 | - X | URL [1..n] | Originate | What protocol(s) this device can originate |
| | | | | (e.g., call). For example, if this device can |
| | | | | call other devices using H.323, the device |
| | | | | will put H323:199.203.72.199 in this field. |
| 9 | - X | URL [1..n] | Terminate | What protocol(s) this device can terminate |
| | | | | (e.g. answer when called). For example, if |
| | | | | this device can answer other devices using |
| | | | | H.323, the device will put |
| | | | | H323:199.203.72.199:1720 in this field. |
| 10 | - X | Codec | Codecs | What codecs are supported by this device. |
| | | [1..n] | | Possible values are defined in Annex A. |
| 11 | - X | DeviceInfo | DeviceInfo | Build and OS information about the client. |
| 12 | - X | Integer64 | LocalTime | First element is Local time where the device |
| | | | | is running. Time is expressed based on the |
| | | | | UNIX standard (e.g. seconds since 1970). |
| | | | | This parameter must be implemented as a |
| | | | | 64-bit integer value. |
| 13 | - X | String | BLHash | The hash value for the current client replica |
| | | | | of the address book, as described in section |
| | | | | 5.7.1. This element must be provided only |
| | | | | when the Families element contains the “A” |
| | | | | element. |
| 14 | - X | String | MsgCookie | The last MsgCookie value provided by the |
| | | | | server (if available). |
| 15 | - X | String | PolicyCookie | The last PolicyCookie value provided by |
| | | | | the server (if available). |
| 16 | - X | String | SelectedPolicy | The current selected policy. |

M: Mandatory
O: Optional

Online.Accept Reply-FIG. 8b

| # | M O | Type | Tag | Details |
|---|---|---|---|---|
| 1.. | Parameters as defined in Generic Verb Accept -Figure 7e | | | |
| 5 | | | | |
| 6 | X - | String | SessionID | A session identifier provided by the |
| | | | | server that the device must use in all |
| | | | | future transactions. |
| 7 | X - | String | SesKey | Secure session key returned by the |
| | | | | server. |
| 8 | X - | Integer64 | GMTTime | The server returns the GMT-Time (e.g., |
| | | | | UTC) to the client. The client must save |
| | | | | the server-time for later use. |
| 9 | - X | UTF8 | SourceDisplay | The display name of logged on user |
| | | | Name | |
| 10 | - X | String [1-n] | BLStatus | The status of all online buddies |
| 11 | - X | URL | RedirectServers | Alternate Servers to use for every |
| | | | [1..n] | further transaction with the exception of |
| | | | | the KeepAlive transaction. The client |
| | | | | must start with the first server provided, |
| | | | | and use the next serves only if it does |
| | | | | not get a reply. |
| 12 | - X | URL | KeepAliveServers | If provided, all future KeepAlive |
| | | | [1..n] | messages must be sent to one of the |
| | | | | provided servers. The client must start |
| | | | | with the first server provided, and use |
| | | | | the next serves only if it does not get a |
| | | | | reply. |

M: Mandatory
O: Optional

KeepAlive

Clients inform the server that they are still available for communications using the KeepAlive verb. If this transaction is rejected the client must issue a new Online transaction.

KeepAlive Verb-FIG. 8c

| # | M O | Type | Tag | Details |
|---|---|---|---|---|
| 1.. | Parameters as defined in Generic Verb Headers - Figure 7a | | | |
| 5 | | | | |
| 6 | X - | String | SelfIP | The IP address of the client as the client |
| | | | | sees it. |
| 7 | - X | String | Calls | Identifiers of calls that are currently in- |
| | | [1..n] | | progress by this device (the call ID was |
| | | | | provided in the Call.accept by the server). |
| 8 | - X | String | BLCookie | The hash value for the current client replica |
| | | | | of the address book, as described in section |
| | | | | 5.7.1. This element must be provided only |
| | | | | when the Families element contains the “A” |
| | | | | element. |
| 9 | - X | String | MsgCookie | The last MsgCookie value provided by the |
| | | | | server (if available). |
| 10 | - X | String | PolicyCookie | The last PolicyCookie value provided by |
| | | | | the server (if available). |
| 11 | - X | String | SelectedPolicy | The current selected policy ID. |

M: Mandatory
O: Optional

KeepAlive.Accept Reply-FIG. 8d

| | | | | |
|---|---|---|---|---|
| # | M O | Type | Tag | Details |

| | |
|---|---|
| 1.. | Parameters as defined in Generic Verb Accept |
| 5 | Header-Figure 7e |

M: Mandatory
O: Optional

Offline

Clients inform the server that they are off-line and no longer available by using the Offline transaction. This transaction is functionally equivalent to ITU-T H.225.0 RAS URQ/UCF/URJ sequence and to IETF RFC 2543 REGISTER(Expires=0) procedure.

The server may time issue an Offline transaction to a client at any to make that client offline. The client must verify that the Session-ID is correct (e.g. the Session-ID that was previously provided by the server) and if it is, accept this transaction.

Offline Verb-FIG. 8e

| | | | | |
|---|---|---|---|---|
| # | M O | Type | Tag | Details |

| | |
|---|---|
| 1.. | Parameters as defined in Generic Verb Header |
| 5 | Fields-Figure 7a |

M: Mandatory
O: Optional

Offline.Accept Reply-FIG. 8f

| | | | | |
|---|---|---|---|---|
| # | M O | Type | Tag | Details |

| | |
|---|---|
| 1.. | Parameters as defined in Generic Verb Accept |
| 5 | Header-Figure 7e |

M: Mandatory
O: Optional

Calls Transactions

These transactions allow clients to:

place calls (using the Call transaction);

request permission from the server to answer calls (using the CallAnswer transaction);

Inform the server that the call has started (using the CallStarted transaction);

inform the server that the call has ended (using the CallEnded transaction);

and allow the server to disconnect a call (using the CallTerminate transaction).

Every call is assigned a Call-ID (a unique string identifying the call) by the server on the Call.accept reply, and this value must be passed to the called-party as it must provide the Call-ID to the server in it's CallAnswer verb.

A client may maintain any number of calls to any number of clients, including multiple calls to the same client, and the server must assign every call with a unique Call-ID. The server may limit calls based on some internal or external policy decisions.

Call

A client must use the Call transaction when it wishes to call another client. The Call transaction provides similar functionality to the H.323 RAS LRQ+ARQ sequences, or to the SIP INVITE sequence. The server may accept the call (using the Call.accept reply) or reject the call (using the Call.reject reply), if the client is not allowed or cannot place the call.

1 or more QoS tokens should be included in the Call verb to request specific QOS for this communication session. If more then one token is provided, the server must assume the client provided them in order of preference.

The Call.wait, Call.redirect, and Call.reject replies shall follow the definitions in section 5.3.

Call Verb-FIG. 8g

| # | M O | Type | Tag | Details |
|---|---|---|---|---|
| 1.. | Parameters as defined in Generic Verb Header Fields- Figure 7a | | | |
| 5 | | | | |
| 6 | X - | Alias | DestAlias | The alias of the remote client that this |
| | | | | client wishes to call. |
| 7 | - X | URL [1..n] | Originate | What protocol(s) this device wishes to use. |
| | | | | This field must be used only if the client |
| | | | | wishes to provide a different set of |
| | | | | protocols then what it provided in the last |
| | | | | Online message. |

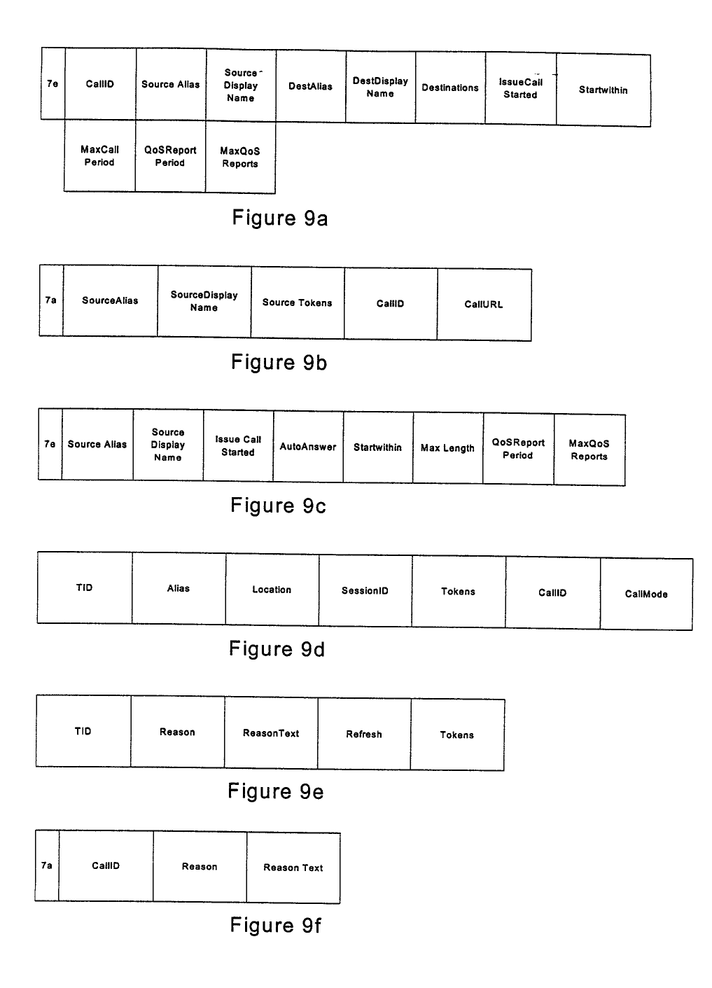

Call.accept Reply - Figure 9a

1 or more QoS tokens should be included in the Call.accept reply by the server to direct the client to use specific QoS for this communication session. If more then one token is provided, the client must assume the server provided them in order of preference.

| # | M | O | Type | Tag | Details |
|---|---|---|---|---|---|
| 1 . . . 5 | Parameters as defined in section Generic Accept Header Fields- FIG. 7e | | | | |
| 6 | X | — | String | CallID | The Call-ID that is assigned by the server |
| | | | | | for this call. Must be passed in whatever |
| | | | | | signaling protocol is used to the called side. |
| 7 | — | X | Alias | SourceAlias | The alias of the calling client, as provided |
| | | | | | by the server. The client must use this alias |
| | | | | | when assembling the target signaling |
| | | | | | protocol. |
| 8 | — | X | UTF8 | SourceDisplayName | The display name of the calling client, as |
| | | | | | provided by the server. The client must use |
| | | | | | this alias when assembling the target |
| | | | | | signaling protocol. |
| 9 | — | X | Alias | DestAlias | The Alias of the Called entity. |
| 10 | — | X | UTF8 | DestDisplayName | The Display name of the device, to be used |
| | | | | | by the client's UI. |
| 11 | — | X | Struct | Destinations | Options for each destination. Options struct |
| | | | [1 . . . n] | | definitions will be described hereafter. |
| | | | | | There must be as many option elements as |
| | | | | | there are destination elements. |
| 12 | — | X | Boolean | IssueCallStarted | If this flag is set, the client must issue the |
| | | | | | CallStarted transaction. |
| 13 | — | X | Period | Start Within | Time until the call must start. If the call is |
| | | | | | not started within <Start-Within> seconds, |
| | | | | | the call must be dropped. |
| | | | | | This field may be required when the |
| | | | | | termination of the call is provided a time- |
| | | | | | limited Token. |
| 14 | — | X | Period | MaxCallPeriod | The maximum length for the call. The |
| | | | | | client must disconnect the call before this |
| | | | | | period is exceeded. |
| 15 | — | X | Period | QoSReportPeriod | Period at which QoS reports are generated |
| | | | | | and provided to the server. |
| 16 | — | X | Integer | MaxQoSReports | Maximum number of QoS reports to be |
| | | | | | provided - if more reports were |
| | | | | | accumulated, they must be merged. |

Supported Option Tags for the DestinationsOptions Element Are:

| # | M | O | Type | Tag | Details |
|---|---|---|---|---|---|
| 1 | X | — | URL | Destination | Destination to signal to - to place the call |
| 2 | — | X | Integer[1 . . .n] | Token | Which tokens are associated with every URL |
| | | | | | (by Token index location). In this example |
| | | | | | the first 3 tokens provided in the transaction |
| | | | | | are associated with the first PrefixURL, |
| | | | | | while the second PrefixURL is associated |
| | | | | | with the 2^{nd} and 3^{rd} Tokens. |
| 3 | — | X | String[1 . . . n] | Continue | Defines what the client MUST do after |
| | | | | | termination of current destination: |
| | | | | | Callend: contact the next destination after |
| | | | | | the call has completed. |
| | | | | | Noanswer: contact the next destination if the |
| | | | | | current destination did not answer (when it is |
| | | | | | off-line or not responding). |
| | | | | | Busy: contact the next destination if the |
| | | | | | current destination did not answer because it |
| | | | | | was busy (e.g. possibly in another call). |
| | | | | | Reject: contact the next destination if the |
| | | | | | current destination rejected the call. |
| | | | | | All: is specified, the client must contact the |
| | | | | | next destination regardless of what happened |
| | | | | | to the current call. |
| 4 | — | X | Integer | Period | The Period parameter defines what is the |
| | | | | | time (in seconds) to attempt contacting the |
| | | | | | provided destination. |
| 5 | — | X | String | Group | Define a group of destinations as the same |
| | | | | | real destination: |
| | | | | | All destination within a group (up to the # set |
| | | | | | by Set) may be contacted at once. The first |
| | | | | | to answer is the right one. |
| | | | | | Upon a failure in one destination in a group |
| | | | | | (busy), the entire group should be skipped. |
| | | | | | Make this destination a part of the given |
| | | | | | group. Upon failure to access one destination |
| | | | | | in a group, the entire group is skipped. |
| 6 | — | X | String | CallMode | An identifier the server defines per- |
| | | | | | destination. Client should return this value in |
| | | | | | CallStart and CallEnd |
| 7 | — | X | Integer | Set | The maximum number of destination (within |
| | | | | | a group) that the client MAY contact |
| | | | | | simultaneously. Default = 1 (that is, no |
| | | | | | simultaneous calls are allowed) |
| 8 | — | X | UTF8 | Name | Destination display name |

EXAMPLES

Trying a PC-Client destination, with text message fail-over:

| Field | Destinations | DestinationsOptions |
|---|---|---|
| 1 | h323:64.209.198.169:1720 | {Continue=all, Period=20} |
| 2 | Im.tgp:gur | |

Trying a GW destination, with email fail-over if the phone is busy or rejected.

| Field | Destinations | DestinationsOptions |
|---|---|---|
| 1 | V2.H323:64.209.198.169:1720:el64.from | {Continue= |
| | =+97235236734:e164.to=+12012287000:f | {busy,reject}, |
| | rom.alias=gur | Period=20} |
| 2 | mailto :gur@mail.trulyglobal.com | |

Trying 2 PSTN destinations one after the other, with message fail-over.

| Field | Destinations | DestinationsOptions |
|---|---|---|
| 1 | V2.H323:64.209.198.169:1720:el64.from | {Continue=all, |
| | =+97235236734:e164.to=+12012287000:f | Period=6, |
| | rom.alias=gur | Token=1} |
| 2 | V211323:64.209.198.169:1720:e164.from | {Continue=all, |
| | =+97235236734:e164.to=+12012287016:f | Period=6, |
| | rom.ahas=gur | Token=2} |
| 3 | mailto:gur@mail.trulyglobal.com | |

CallAnswer

When receives a call using some supported signaling protocol, it must silently (e.g., without alerting the user) request permission from the server to answer the call. If such permission is NOT granted, the client must reject the call.

1 or more QoS tokens should be included in the CallAnswer verb to request specific QoS for this communication session. If more then one token is provided, the server must assume the client provided them in order of preference.

If the CallAnswer is accepted, the client must alert the user (probably using a ringing tone) to allow him/her to answer the call.

The server may reject the call if the client is not allowed or cannot answer the call using the Call.reject reply.

The CallAnswer.wait, CallAnswer.redirect, and CallAnswer.reject replies shall follow the definitions in section 5.3.

CallAnswer Verb-FIG. 9b

| # | M | O | Type | Tag | Details |
|---|---|---|---|---|---|
| 1 . . . 5 | | | Parameters as defined in Generic Header Fields- FIG. 7a | | |
| 6 | — | X | Alias | SourceAlias | The alias of the client that is calling |
| 7 | — | X | UTF8 | SourceDisplayName | The display name of the caller. |
| 8 | — | X | Token | SourceTokens | Tokens provided by the called entity |
| | | | [1 . . . n] | | signaling channel (e.g., any tokens provided |
| | | | | | in the H.323 SETUP message). |
| 9 | X | — | String | CallID | The CallID that is provided by the calling |
| | | | | | client. |
| 10 | X | — | URL | CallURL | Information about that call, including the IP |
| | | | | | address of the caller, and other parameters, |
| | | | | | for example (same format as Call.accept |
| | | | | | (Destinations )): |
| | | | | | H323: 199.203.72.1:80 |

CallAnswer.Accept Reply-FIG. 9c

1 or more QoS tokens should be included in the CallAnswer.accept reply by the server to direct to use specific QoS for this communication session. If more then one token is the client must assume the server provided them in (first to last) order of preference.

| # | M | O | Type | Tag | Details |
|---|---|---|---|---|---|
| 1 . . . 5 | | | Parameters as defined in Generic Verb Header Fields- FIG. 7a | | |
| 6 | — | X | Alias | SourceAlias | An Alias of the user, may be the same or |
| | | | | | different then the DisplayName. |
| 7 | — | X | UTF8 | SourceDisplayName | A name that must be used by the client to |
| | | | | | visually identify the caller |
| 8 | — | X | Boolean | IssueCallStarted | If this flag is set, the client must issue the |
| | | | | | CallStarted transaction. If the field does not |
| | | | | | exist, it means that the client is not required |
| | | | | | to issue the CallStarted verb. |
| 9 | — | X | Period | AutoAnswer | If larger then zero (0), the client must answer |
| | | | | | the call automatically without waiting for the |
| | | | | | user to respond to the user has not responded |
| | | | | | by <Period> seconds. |
| 10 | — | X | Period | StartWithin | Time until the call must start. If the call is |
| | | | | | not started within <Start-Within> seconds, |
| | | | | | the call must not be answered. |
| 11 | — | X | Period | MaxLength | The maximum length for the call. The client |
| | | | | | must disconnect the call before this period |
| | | | | | exceeded. |
| 12 | — | X | Period | QoSReportPeriod | Period at which QoS reports are generated |
| | | | | | and provided to the server. |
| 13 | — | X | Integer | MaxQoSReports | Maximum number of QoS reports to be |
| | | | | | provided - if more reports were |
| | | | | | accumulated, they must be merged. |

CallStarted

When a call is started (e.g., voice, video or other media is first transmitted from either direction), the client must inform that server using the CallStarted transaction. If the CallStarted transaction is rejected (using the CallStarted.reject reply), the call must be dropped, and an CallEnded(Reason=Server-forced-early-termination) transaction must be issued.

The QoS of the call must be reported using a QoS token (information that is not yet available, such is packet-loss and jitter-may be skipped).

The CallStarted.wait, CallStarted.redirect, and CallStarted.reject replies shall follow the definitions in the generic verb sections.

CallStarted Verb- FIG. 9d

| # | M | O | Type | Tag | Details |
|---|---|---|---|---|---|
| 1 . . . 5 | Parameters as defined in the Generic Verb Header Fields- FIG. 7a | | | | |
| 6 | X | — | String | CallID | The Call-ID of the call that was started. |
| 7 | X | — | String | CallMode | The Callmode value returned in Call.accept |
| | | | | | for this destination. |

CallStarted.Accept Reply- FIG. 9e

| | | | | | |
|---|---|---|---|---|---|
| # | M | O | Type | Tag | Details |

| | |
|---|---|
| 1 . . . 5 | Parameters as defined in Generic Verb Accept Header Fields- FIG. 7e |

CallTerminate

The CallTerminate transaction is sent from the server to the client to terminate an on-going call. The client must accept this transaction, terminate the call, and issue a CallEnded transaction with reason=server-forced-termination.

The client must not reply with any of: CallTerminate.wait, CallTerminate.redirect, or Callterminate.reject replies.

CallTerminate Verb- FIG. 9f

| # | M | O | Type | Tag | Details |
|---|---|---|---|---|---|
| 1 . . .5 | Parameters as defined in Generic Verb Header Fields- FIG. 7a | | | | |
| 6 | X | — | String | CallID | The Call-ID of the call that is to be ended. |
| 7 | X | — | Reason | Reason | The reason why the call is being dropped. |
| 8 | — | X | UTF8 | ReasonText | A textual message that can be used by the |
| | | | | | client's user interface. |

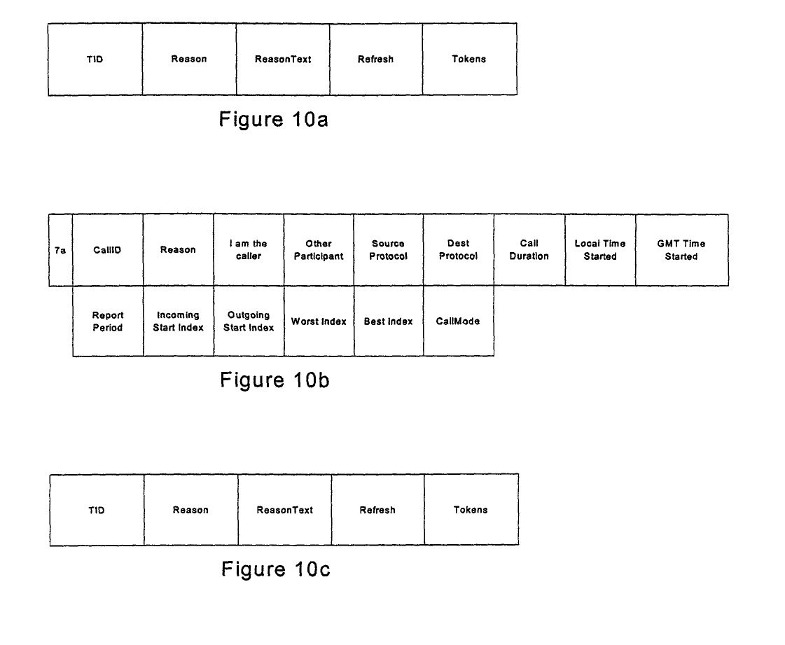

CallTerminate.Accept Reply-FIG. 10a

| | | | | | |
|---|---|---|---|---|---|
| # | M | O | Type | Tag | Details |

| | |
|---|---|
| 1.. | Parameters as defined in Generic Verb Accept Header Field-FIG. 7e |
| 5 | |

CallEnded

The CallEnded transaction must be issued by both sides of a call as soon as the call is terminated. It contains all the information required to create a CDR for the just-ended call. The CallEnded.wait, CallEnded.redirect, and CallEnded.reject replies shall follow the definitions in the Generic Verb Wait, Redirect and Reject sections.

CallEnded Verb-FIG. 10b

The Quality of the call must be provided in one or more QoS tokens. The incoming quality, outgoing quality, and best/worst quality must be reported.

| # | M | O | Type | Tag | Details |
|---|---|---|---|---|---|
| 1.. | Parameters as defined in section | | | | |
| 5 | Generic Verb Header Fields-FIG. 7a | | | | |
| 6 | X | — | String | CallID | The Call-ID of the call that has |
| | | | | | ended. |
| 7 | X | — | Reason | Reason | Why the call was dropped. |
| 8 | X | — | Boolean | IamThe | Set to TRUE if this client is the |
| | | | | Caller | initiator of the call. |
| 9 | — | X | Alias | Other | The other party that participated |
| | | | | Participant | in the call. This participant |
| | | | | | (the one sending this message) is |
| | | | | | identified in the primary alias |
| | | | | | field (field #2). |
| 10 | X | — | URE | Source | Signaling protocol used for the |
| | | | | Protocol | call including IP addresses, |
| | | | | | caller first, called- party second. |
| 11 | X | — | URL | DestProtocol | |
| 12 | X | — | Period | CallDuration | The duration in seconds of the |
| | | | | | call. |
| 13 | — | X | Integer64 | LocalTime | The Local time when the call |
| | | | | Started | started. Time is expressed based |
| | | | | | on the UNIX standard |
| | | | | | (e.g., seconds since 1970). |
| 14 | — | X | Integer64 | GMTTime | GMT time when the call started. |
| | | | | Started | Time is expressed based on the |
| | | | | | UNIX standard (e.g., seconds |
| | | | | | since 1970). |
| 15 | — | X | Integer | ReportPeriod | If more then one report period |
| | | | | | (e.g., less then the duration |
| | | | | | of the call), then the report |
| | | | | | period is provided here. If the |
| | | | | | whole call is reported, then this |
| | | | | | value must be set to 0 (zero). |
| | | | | | A value of 60 is recommended |
| | | | | | (a set of incoming + outgoing |
| | | | | | tokens for every minute in |
| | | | | | the call). |
| 16 | — | X | Integer | Incoming | The location of the first |
| | | | | Startindex | incoming quality token. If the |
| | | | | | call duration is 5 minutes, and |
| | | | | | the reporting period is 60 |
| | | | | | (seconds), the 5 tokens |
| | | | | | beginning at this location will |
| | | | | | report on the incoming quality. |
| 17 | — | X | Integer | Outgoing | The location of the first |
| | | | | StartIndex | incoming quality token. If the |
| | | | | | call duration is 7 minutes, and |
| | | | | | the reporting period is 60 |
| | | | | | (seconds), the 7 tokens |
| | | | | | beginning at this location will |
| | | | | | report on the incoming quality. |
| 18 | — | X | Integer | WorstIndex | Index of the token defining the |
| | | | | | worst quality encountered in |
| | | | | | the call. |
| 19 | — | X | Integer | BestIndex | Index of the token defining the |
| | | | | | best quality encountered in the |
| | | | | | call. |
| 20 | X | — | String | Calimode | The CallMode value returned |
| | | | | | in Call.accept for this |
| | | | | | destination. |

CallEnded.Accept Reply-FIG. 10c

| | | | | | |
|---|---|---|---|---|---|
| # | M | O | Type | Tag | Details |

| | |
|---|---|
| 1.. | Parameters as defined in section Generic |
| 5 | Verb Accept Header Fields-FIG. 7e |

BuddyList Transactions

The BuddyList (BL for short) transaction set allows a client to get updates and make changes to the buddy list. Specifically the client may receive messages that instruct it to add, delete or modify a buddy list entry or a complete replacement for all address book entries. The server maintains the Buddy List “master replica”, and when the list changes, pushes these changes to the client.

Integration with Presence Transactions

To insure the buddy list is replicated correctly in the client, the client must maintain an up-to-date 64-bit integer hash value calculated using all PrimaryAlias+DisplaName values, alphanumerically-ascending sorted, and send this value to the server in every Online (. . . |BLCookie) message.

The server will match this hash value with a local calculated value, and if it finds that the client's address book does not match the server copy, will send a BLReplaceAll or BLAdd (which may replace some or all elements in the buddy list) as a separate reply after the Online.accept reply.

In addition, the server must send a BLStatus or BLStatusAll message with the status of all address book entries (e.g., online, offline etc) immediately after the first Online.accept reply and whenever the status of an buddy list entry changes.

Status Encoding

The status parameter is a complex type that is binary in nature. Each element in the status array is a numbered media type (e.g., text, audio, video, etc). Each media type is allocated an enumerator describing what level of interactivity the media type supports:

| Interactivity | | Status |
|---|---|---|
| Type | What it Means | ID |
| Unavailable | Communications with this media type is | 0 |
| | impossible | |
| Supported | Communications with this media type is | 1 |
| | possible, with no further information. | |
| Non-Interactive | Communications with this media type is | 2 |
| | possible, and it is known to be non-interactive | |
| | (e.g. Text message instead of text-chat, | |
| | voice-mail instead of voice-call) | |
| Interactive | Communications with this media type is | 3 |
| | possible, and it is known to be interactive | |
| | (e.g. text-chat instead of text message, | |
| | voice-call instead of voice-mail) | |

Media Types

| Location in | |
|---|---|
| Array | Media Type |
| 1 | Text |
| 2 | Audio |
| 3 | Video |

Example

| PrimaryAlias | DisplayName | Status |
|---|---|---|
| Ost | Ofer Shem-Tov | (3, 1, 0) |
| Gur | Gur Kimchi | (2, 1, 3) |
| spencermah | Michael Spencer | (1, 0, 0) |

Encoding:

BLModifyAll( PrimaryAlias=(ost,gur),

DisplayName=(Ofer Shem-Tov, Gur Kimchi),

Status=((3,1,0),(3,0,3)))

BLAdd

This transaction allows the user to request the server to add a new buddy list entry to the local replica of the buddy list when sending it to the Server, or when received from the server, the client is required the add the provided entries to it's buddy list. If an entry with the same name is already in the buddy list, that entry must be replaced with the provided entry.

Note that when the client sends this transaction to the server, the server will accept the transaction (using BLAdd.accept) but all that means is that the server accepts the transaction-this does not mean that the client can add the entry to it's buddy list. The client may add a buddy list entry only when it receives a BLAdd message from the server (which could be the immediately next message).

When the client receives a BLAdd message from the server, it is not required to send an BLAdd.accept back to the server-e.g. the server to client BLAdd message is not a true transaction.

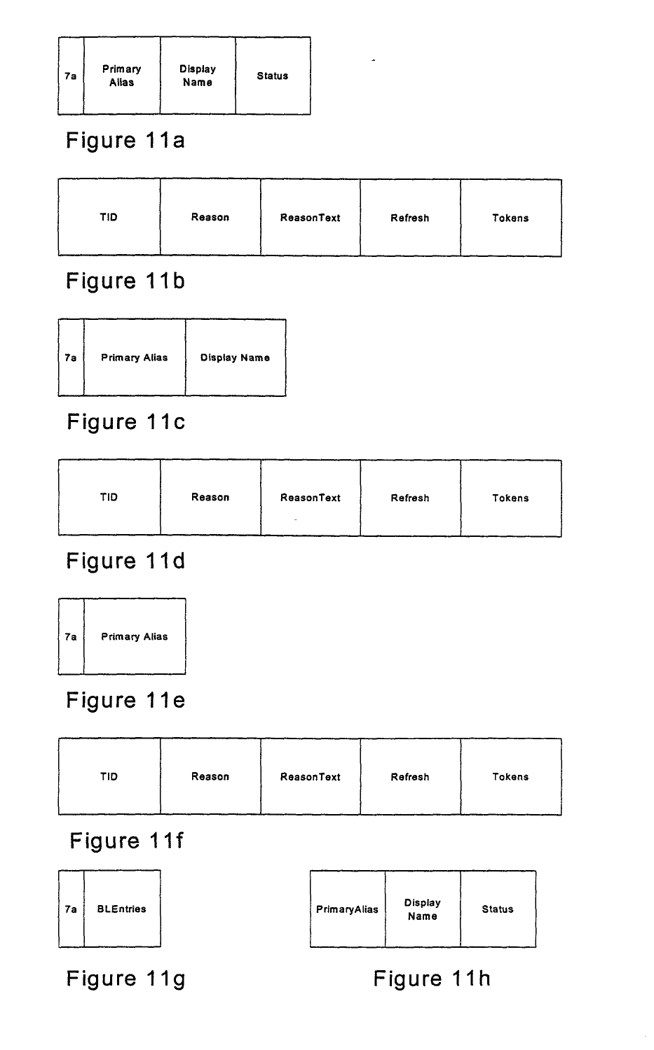

BLAdd Verb-FIG. 11a

| # | M | O | Type | Tag | Details |
|---|---|---|---|---|---|
| 1.. | Parameters as defined in Generic | | | | |
| 5 | Verb Headings-FIG. 7a | | | | |
| 6 | X | — | Alias | PrimaryAlias | The PrimaryAlias(s) of the |
| | | | | | buddy list entries to add. |
| 7 | — | X | UTF8 | DisplayName | The DisplayName(s) of the |
| | | | | | buddy list entries to add. |
| | | | | | The same number of elements as |
| | | | | | PrimaryAlias must be provided, |
| | | | | | and if a DisplayName is not |
| | | | | | available, and empty string may |
| | | | | | be provided for that array |
| | | | | | element. |
| 8 | — | X | Integer | Status | The current status of the new |
| | | | | | entry. |

BLAdd.Accept Reply-FIG. 11b

| | | | | | |
|---|---|---|---|---|---|
| # | M | O | Type | Tag | Details |

| | |
|---|---|
| 1.. | Parameters as defined in Generic Verb |
| 5 | Accept Header Field-FIG. 7e |

BLModify

The BLModify verb is used the change the display name of an entry in the buddy list.

BLModify Verb-FIG. 11c

| # | M | O | Type | Tag | Details |
|---|---|---|---|---|---|
| 1.. | Parameters as defined in Generic | | | | |
| 5 | Verb Headings-FIG. 7a | | | | |
| 6 | X | — | String | PrimaryAlias | The PrimaryAlias(s) of the |
| | | | | | address book entry to add. |
| 7 | — | X | StringUTF8 | DisplayName | The DisplayName(s) of the |
| | | | | | address book entry to add. |

BLModify.Accept Reply-FIG. 11d

| | | | | | |
|---|---|---|---|---|---|
| # | M | O | Type | Tag | Details |

| | |
|---|---|
| 1.. | Parameters as defined in Generic |
| 5 | Verb Accept Header Field-FIG. 7e |

BLRemove

This transaction allows the user to request the server to remove an existing address book entry from the local replica of the address book when sending it to the Server, or when received from the server, the client is required to delete the provided user(s) from it's address book.

When the client sends this transaction to the server, the server will accept the transaction (using BLRemove.accept) but all that means is that the server accepts the transaction—this does not mean that the client can remove the entry from it's address book. The client may remove an address book entry only when it receives a BLRemove message from the server.

When the client receives a BLRemove message from the server, it is not required to send a BLRemove.accept back to the server-e.g. the server to client BLRemove message is not a true transaction.

BLRemove Verb-FIG. 11e

| # | M | O | Type | Tag | Details |
|---|---|---|---|---|---|
| 1.. | Parameters as defined in | | | | |
| 5 | Generic Verb Headings-FIG. 7a | | | | |
| 6 | X | — | String | PrimaryAlias | The address book PrimaryAlias's |
| | | | | | of the entries to deleted. |

BLRemove.Accept Reply-FIG. 11f

| | | | | | |
|---|---|---|---|---|---|
| # | M | O | Type | Tag | Details |

| | |
|---|---|
| 1 . . . | Parameters as defined in Generic Verb Accept Header Field- |
| 5 | FIG. 7e |

BLModifyAll

This transaction allows the user to request the server to replace the entire local replica of the address book when sending it to the server, or when received from the server, the client must replace it's address book with the provided list of entries.

When the client receives a BLModifyAll message from the server, it is not required to send a BLModifyAll.accept back to the server-e.g. the server to client BLModifyAll message is not a true transaction.

All Verb-FIG. 11g

| # | M | O | Type | Tag | Details |
|---|---|---|---|---|---|
| 1.. | Parameters as defined in Generic Verb Headings- FIG. 7a | | | | |
| 5 | | | | | |
| 6 | X | — | Struct[1−n] | BlEntries | Address book entries |

BLEntries Struct-FIG. 11h

| # | M | O | Type | Tag | Details |
|---|---|---|---|---|---|
| 1 | X | — | String | PrimaryAlias | The PrimaryAlias of the |
| | | | | | address book entry to add. |
| 2 | X | — | UTF8 | DisplayName | The DisplayName of the |
| | | | | | address book entry to add. |
| 3 | — | X | Integer | Status | Status of added or modified |
| | | | | | entry. |

Example:
BLEntries = {(PrimaryAlias=user1,DisplayName=user1,Status=3),(PrimaryAlias=user2,DisplayName=user2,Status=2),(PrimaryAlias=user3,DisplayName=user3,Status=3)}

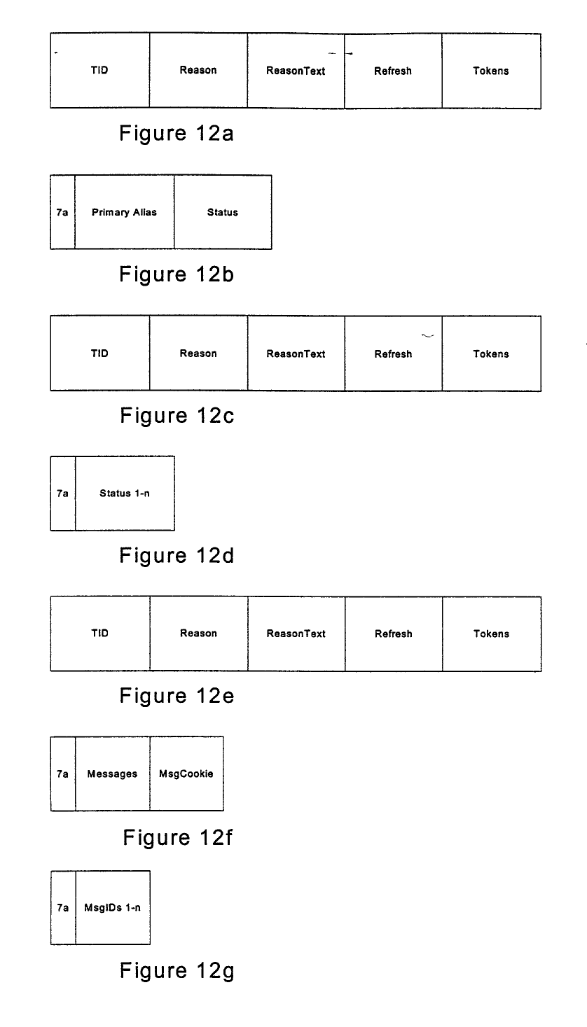

BLModifyAll.Accept Reply-FIG. 12a

| | | | | | |
|---|---|---|---|---|---|
| # | M | O | Type | Tag | Details |

| | |
|---|---|
| 1.. | Parameters as defined in Generic Verb Accept Header Fields- FIG. 7a |
| 5 | |

BLStatus

The BLStatus message is sent by the server to the client to update the status of a single buddy list entry. The BLStatus must be sent whenever the status of a single entry is changed.

BLStatus Verb-FIG. 12b

| # | M | O | Type | Tag | Details |
|---|---|---|---|---|---|
| 1.. | Parameters as defined in Generic Verb Headings- FIG. 7a | | | | |
| 5 | | | | | |
| 6 | X | — | String | PrimaryAlias | The PrimaryAlias of the entry for |
| | | | | | which the status has changed. |
| 7 | X | — | Integer | Status | The new status of all buddy |
| | | | | | list entry. |

BLStatus.Accept Reply-FIG. 12c

| | | | | | |
|---|---|---|---|---|---|
| # | M | O | Type | Tag | Details |

| | |
|---|---|
| 1.. | Parameters as defined in Generic Verb Accept Header Fields- FIG. 7e |
| 5 | |

BLStatusAll

The BLStatusAll message is send by the server to the client to update it's buddy list as to the status of every entry. The BLStatusAll must be sent whenever the status of the buddy list is substantially changed, such as when the client connects for the first time and the buddy list entries (Vs. the status) did not change.

BLStatusAll Verb-FIG. 12d

| # | M | O | Type | Tag | Details |
|---|---|---|---|---|---|
| 1.. | Parameters as defined in Generic Verb Headings- FIG. 7a | | | | |
| 5 | | | | | |
| 6 | — | X | Integer | Status [1..n] | The status of all address book |
| | | | | | entries, assuming the address |
| | | | | | book is alphanumerically- |
| | | | | | ascending sorted. |

BLStatusAll.Accept Reply-FIG. 12e

| | | | | | |
|---|---|---|---|---|---|
| # | M | O | Type | Tag | Details |

| | |
|---|---|
| 1.. | Parameters as defined in Generic Verb Accept Header Fields- FIG. 7e |
| 5 | |

Messaging Transactions

The messaging transactions family allows clients and servers (and other clients) to exchange message.

MsgAvailable

The MsgAvailable transaction is sent by the server to inform the client about new messages available in the server. The client never responds directly (in the form of a MsgAvailable.accept reply) to the MsgAvailable verb.

MsgAvailable Verb-FIG. 12f

| # | M | O | Type | Tag | Details |
|---|---|---|---|---|---|
| 1.. | Parameters as defined in Generic Verb Headings- FIG. 7a | | | | |
| 5 | | | | | |
| 6 | X | — | Struct[1−n] | Messages | New messages available |
| | | | | | to the server. |
| 7 | — | X | String | MsgCookie | A value provided by the |
| | | | | | server used to keep track of |
| | | | | | the last change that was made |
| | | | | | to the client-view of the |
| | | | | | message list. |

Messages Struct

| # | M | O | Type | Tag | Details |
|---|---|---|---|---|---|
| 1 | X | — | String | MsgID | The ID of unread message |
| 2 | X | — | String | MsgType | |
| 3 | — | X | String | ThreadID | |
| 4 | — | X | String | ReplyToID | |
| 5 | — | X | String | WhenSent | |
| 6 | — | X | String | SenderAlias | |
| 7 | — | X | UTF8 | SenderDisplayName | |
| 8 | — | X | String | MsgLanguage | |
| 9 | — | X | UTF8 | Msg | |

MsgGet

The MsgGet transaction is sent by the client to request the server to provide it with more new message. The server should issue multiple Msg transactions immediately before the MsgGet.accept reply. The server may reject the MsgGet transaction if one or more of the MsgIDs fields are illegal.

MsgGet verb-FIG. 12g

| # | M | O | Type | Tag | Details |
|---|---|---|---|---|---|
| 1.. | Parameters as defined in Generic Verb Headings- FIG. 7a | | | | |
| 5 | | | | | |
| 6 | X | — | String | MsgIDs [1..n] | The ID of the messages the |
| | | | | | client is asking for. |

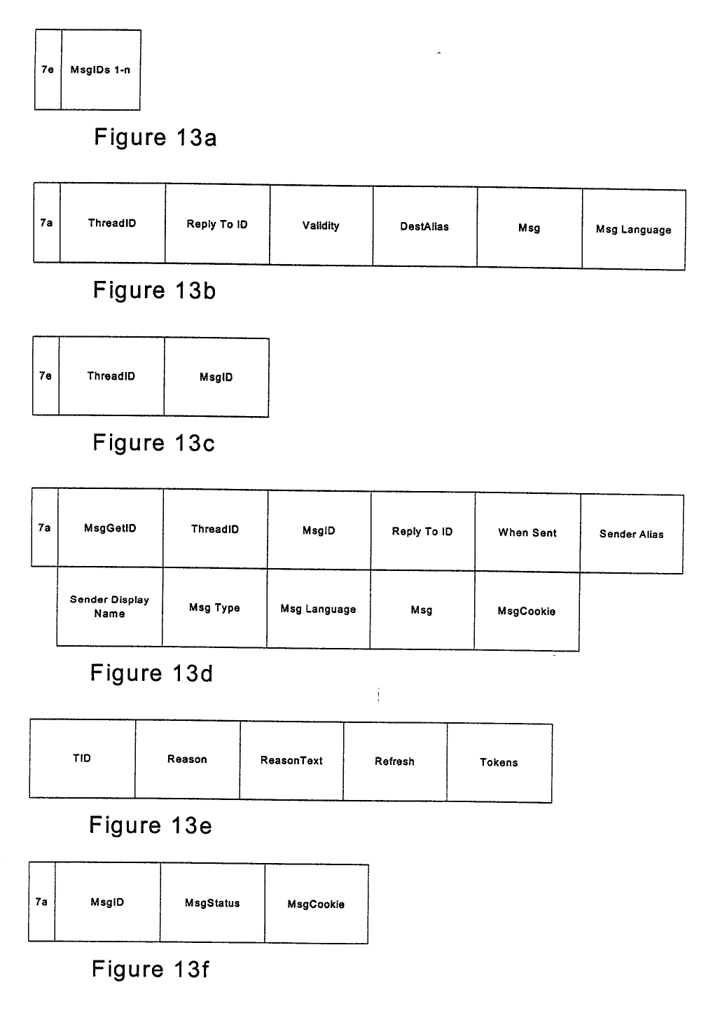

MsgGet.Accept Reply-FIG. 13a

| # | M | O | Type | Tag | Details |
|---|---|---|---|---|---|
| 1.. | Parameters as defined in Generic Verb Accept Header Fields- FIG. 7e | | | | |
| 5 | | | | | |
| 6 | — | X | String | MsgIDs [1..n] | The IDs of the messages that |
| | | | | | will soon be sent using the Msg |
| | | | | | transaction. May be a subset of |
| | | | | | the MsgGet(MsgIDs) list if |
| | | | | | some messages are not available. |

MsgSend

The MsgSend transaction is used by the client to send a message to another client (via the server).

MsgSend Verb-FIG. 13b

| # | M | O | Type | Tag | Details |
|---|---|---|---|---|---|
| 1.. | Parameters as defined in Generic Verb Headings- FIG. 7a | | | | |
| 5 | | | | | |
| 6 | — | X | String | ThreadID | The ID of the message thread, |
| | | | | | if known (if this is the first |
| | | | | | message then it is not known). |
| 7 | — | X | String | ReplyToID | The ID of the message that |
| | | | | | this message is a reply to-if |
| | | | | | available. |
| 8 | — | X | Integer64 | Validity | Seconds since 1-1-1970: if the |
| | | | | | message cannot be provided |
| | | | | | to the user in this amount of |
| | | | | | time, it must be deleted. |
| 9 | X | — | Alias | DestAlias | The alias of the recipient. |
| 10 | — | X | UTF8 | Msg | The textual message itself, up |
| | | | | | to 2048 characters in length. |
| 11 | — | X | String | MsgLanguage | The Language the message |
| | | | | | is in. |

MsgSend.Accept Reply-FIG. 13c

| # | M | O | Type | Tag | Details |
|---|---|---|---|---|---|
| 1.. | Parameters as defined in Generic Verb Accept Header Fields- FIG. 7e | | | | |
| 5 | | | | | |
| 6 | — | X | String | ThreadID | The ID of the message thread, if |
| | | | | | known (if this is the first message, |
| | | | | | then it is not known). |
| 7 | X | — | String | MsgID | The ID of the message sent |
| | | | | | (generated by the server). |

Msg

Msg transaction is used by the server to send a message to client-the message got to the server by the sending-client issuing the Send transaction).

MsgVerb-FIG. 13d

| # | M | O | Type | Tag | Details |
|---|---|---|---|---|---|
| 1.. | Parameters as defined in Generic Verb Headings- FIG. 7a | | | | |
| 5 | | | | | |
| | — | X | String | MsgGetTID | The TID of the GetMsg |
| | | | | | transaction that resulted |
| | | | | | in sending this message. |
| | | | | | This field must not be |
| | | | | | used for server-originated |
| | | | | | (new, unknown to the |
| | | | | | client) messages. |
| 6 | — | X | String | ThreadID | The ID of the message |
| | | | | | thread. |
| 7 | X | — | String | MsgID | The ID of this message. |
| 8 | — | X | String | ReplyToID | The ID of the message that |
| | | | | | this message is a reply |
| | | | | | to-if available. |
| 9 | — | X | Integer | WhenSent | Seconds since 1-1-1970; |
| | | | 64 | | when the message was sent. |
| 10 | X | — | String | SenderAlias | The alias of the sender. In |
| | | | | | the case of type-2 messages |
| | | | | | (system2user messages), |
| | | | | | this field is not optional, |
| | | | | | and the SenderAlias must |
| | | | | | be set to “TrulyGlobal” |
| | | | | | (a reserved TGID). |
| 11 | — | X | UTF8 | SenderDisplayName | The display name of the |
| | | | | | sender. |
| 12 | X | — | Integer | MsgType | The type of the message, as |
| | | | | | defined in later in |
| | | | | | specification |
| 13 | — | X | String | MsgLanguage | The Language the message |
| | | | | | is in. |
| 14 | X | — | UTF8 | Msg | The textual message itself, |
| | | | | | up to 500 characters in |
| | | | | | length. |
| 15 | — | X | String | MsgCookie | A value provided by the |
| | | | | | server used to keep track of |
| | | | | | the last change that was |
| | | | | | made to the client-view of |
| | | | | | the message list. |

Msg.Accept Reply-FIG. 13e

| | | | | | |
|---|---|---|---|---|---|
| # | M | O | Type | Tag | Details |

| | |
|---|---|
| 1.. | Parameters as defined in Generic Verb Headings- FIG. 7a |
| 5 | |

MsgStatus

Is used by the client to request the server to change the status of a message. The server will always accept, and may send a server-initiated MsgStatus immediately afterwards to the client, at which point the client will change the status of the message(s).

MsgStatus Verb-FIG. 13f

| # | M | O | Type | Tag | Details |
|---|---|---|---|---|---|
| 1.. | Parameters as defined in Generic Verb Headings- FIG. 7a | | | | |
| 5 | | | | | |
| 6 | X | — | String | MsgID | The ID of the message that the |
| | | | | | status changed is for. |
| 7 | X | — | Integer | MsgStatus | The new status of the message, as |
| | | | | | defined hereafter. |
| 8 | — | X | String | Msgcookie | A value provided by the server |
| | | | | | used to keep track of the last |
| | | | | | change that was made to the |
| | | | | | client-view of the message list. |

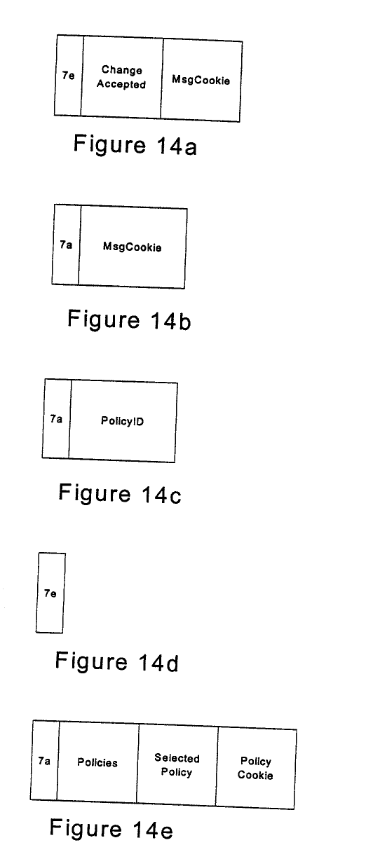

MsgStatus.Accept Reply-FIG. 14a

| # | M | O | Type | Tag | Details |
|---|---|---|---|---|---|
| 1.. | Parameters as defined in Generic Verb Accept Header Fields- FIG. 7e | | | | |
| 5 | | | | | |
| 6 | — | X | Boolean | ChangeAccepted | If set to true the changes the |
| | | | | | client requested were all |
| | | | | | accepted, if not the client |
| | | | | | must not change the local |
| | | | | | state and wait for the server |
| | | | | | to issue the MsgStatus |
| | | | | | messages. |
| 7 | — | X | String | MsgCookie | A value provided by the |
| | | | | | server used to keep track of |
| | | | | | the last change that was made |
| | | | | | to the client-view of the |
| | | | | | message list. |

MsgFlush

Is used by the server to delete all messages stored by the client. This may be done when the server discovers (by checking the LastStatusUpdate values) that the client's messages list is incorrect. The server may send a list of messages immediately after the MsgFlush transaction to the client to re-build the client's message list.

MsgFlush Verb-FIG. 14b

| # | M | O | Type | Tag | Details |
|---|---|---|---|---|---|
| 1.. | Parameters as defined in Generic Verb Headings- FIG. 7a | | | | |
| 5 | | | | | |
| 6 | — | X | String | MsgCookie | A value provided by the server |
| | | | | | used to keep track of the last |
| | | | | | change that was made to the |
| | | | | | client-view of the message list. |

Policy Transactions

The policy transaction set is used by the server to provide the list of available policies to the client and to inform which policy is currently “active”, and for the client to select a new active policy.

Upon successful Online completion, the server may append a PolicyList transaction (if, based on the PolicyCookie, the list was changed).

PolicySelect

The server will issue the PolicySelect transaction when a new policy becomes active. The client will issue the PolicySelect transaction to request a new policy to be selected. Note that the server may choose to select a different policy then what was requested, and will return the now active policy name in the transaction reply.

The server may send a PolicySelect transaction as a result of receiving the PolicySelect from the client.

PolicySelect Verb-FIG. 14c

| # | M | O | Type | Tag | Details |
|---|---|---|---|---|---|
| 1.. | Parameters as defined in Generic Verb Headings- FIG. 7a | | | | |
| 5 | | | | | |
| 6 | X | — | String | PolicyID | The ID of the current active policy |
| | | | | | (when sent from server to client) or |
| | | | | | the policy to select (when sending |
| | | | | | from client to server). |

PolicySelect.Accept Reply-FIG. 14d

| | | | | | |
|---|---|---|---|---|---|
| # | M | O | Type | Tag | Details |

| | |
|---|---|
| 1.. | Parameters as defined in Generic Verb Accept Header Fields- FIG. 7e |
| 5 | |

PolicyList

The server must monitor that state of the client's policy list, and if finding that the list is out of date (by comparing the server PolicyCookie with the client's PolicyCookie provided in the Online transaction), the server will issue a PolicyList transaction. The client must upon receiving the PolicyList transaction to delete all entries in the local policy list and to populate the list with the contents of the Policies field. The index of the selected policy is provided in the SelectedPolicy field, which is an index into the Policies array.

PolicyList Verb-FIG. 14e

| # | M | O | Type | Tag | Details |
|---|---|---|---|---|---|
| 1.. | Parameters as defined in Generic Verb Headings- FIG. 7a | | | | |
| 5 | | | | | |
| 6 | X | — | Struct[1 . . . n] | Policies | List of available policies |
| 8 | X | — | Integer | SelectedPolicy | The index (starting with |
| | | | | | <1> of the currently |
| | | | | | selected policy) |
| 9 | — | X | String | PolicyCookie | A new cookie value. |

Policies Structure

| # | M | O | Type | Tag | Details |
|---|---|---|---|---|---|
| 1 | X | — | String | PolicyID | Policy ID |
| 2 | X | — | UTF8 | PolicyName | Policy name |

Security

Following are implementation details on session-key creation, authentication and verification, and a mechanism for hiding password on clear channels. Current TGP security is based on the shared secret-key model.

General:

1. Client: pdu(tgid, x, h(x,p))

2. Server: pdu(session-Id, sk^{Λ}h(p)), h( h(pdu), sk)

3. Client: pdu(session-Id), h( h(pdu), sk)

Sequence:

1. Client generates x, a random string, and does MD5 hash on x concatenated with its password p, the location I (same parameter provided in Online.location).

2. The client then sends the result of (1) in the Online.key transaction parameter.

3. The server passes the hash and x into the database, to validate the password. Then generates a session key sk, and XORs it with the password hash (without x), and send it in the Online.accept PDU, along with the (normal) session ID. The server then appends the PDU with authentication token, created by concatenating the PDU string (starting with the /tgp, and ending with the “)”, before applying HTTP encoding, if any) with the session key, and hashes using MD5. The client opens the session key (by XORing it back with h(p)), and validates the authentication token.

NOTE: both these steps assume the user password is strong (i.e., not vulnerable to dictionary attacks). To increase security, they should be carried on a secured connection (SSL). The rest of the communication can be carried in the clear.

4. The client can later generate PDUs by appending them with the hash of the PDU concatenated with the session key.

The Message Authentication Token (MAT) is generated by converting the first 8 bytes of the generated value (as defined above) to Hexadecimal.

Operational Parameters

Timers

The following timers shall be used:

| Timer | Details | Value | In |
|---|---|---|---|
| T1 | Time to wait between sending the transaction | 10 | seconds |
| | request and the arrival of the transaction | | |
| | reply. (e.g. one of *.wait, *.redirect, | | |
| | *.accept, or * .reject) | | |
| T2 | New time to wait when a *.wait reply | T1 * 3 | seconds |
| | arrives. | | |

Counters

The following counters shall be used. C1 is used as a protection mechanism to combat loops, while C2 defines how many consecutive connections to the same DNS name are to be attempted. C3 is used as a protection from accidental loops.

| Timer | Details | Value |
|---|---|---|
| C1 | Number of *.redirect or *.wait replies the client may | 5 |
| | accepts for a single transaction. | |
| C2 | Number of consecutive TCP connection attempts to the | 3 |
| | same DNS name before failing. | |
| C3 | Initial Time-to-Live (e.g., TTL) value to be used in | 12 |
| | Transactions in the TransactionID field. This value must | |
| | be reduced by 1 for every element that forwards the | |
| | transaction. If this value reaches 0 it must not be | |
| | forwarded, but rather a Verb.reject be sent to the | |
| | originator of the transaction with an appropriate reason. | |

Calculating the Refresh Timer

The server must return a refresh value to the client. These values dictate how often clients refresh their on-line state, and also the load clients generated on the server. The client must re-send an Online transaction to the server within Online.accept(Refresh) * (0.5+rand( )) to insure smooth transaction distribution.

100,000 clients with a refresh period of 60 seconds will generate a load of 1666 transactions per second, while the same 100,000 clients will generate a load of only 333 transactions per second for a refresh period of 5 minutes.

The server must, based on how many clients are on line, grow the refresh value exponentially to insure the server load does not exceed its processing capabilities. This calculation is similar in principle to Multicast group RTCP transmission timer algorithms.

Encoding

Verb Special Characters

The characters “|,( )=” have special meaning in the Transaction command line and must not be used inside strings or tokens.

If Strings require the use of these characters, they must use length encoding.

The space character must not be used, and shall be replaced with the “+” character when encoding. The “+” character shall be translated back to a space character when decoding.

Verb Parameterization

Transactions must use the HTTP GET verb.

Transactions must be prefixed with a /tgp/v1/ (the protocol header).

Transactions must contain a Verb (e.g., Online for example) or a verb reply (e.g., Online.accept) immediately after the protocol header.

Verb or Verb replies must be followed by “(“, parameter(s), and a closing“)”.

A “/” and a Message Authentication Token (MAT) parameter must follow the closing “)”,as per security section).

Parameters must be separated using a “|”.

Parameters follow the tag=value pattern, where the tag is unique (e.g., Alias=alex). The “=” (equals) character must be used to separate the tag from the value.

Tags must only contain the a . . . z, A . . . Z, and “−” characters.

Tags must be encoded as case sensitive.

String parameters may contain a length Indicator (e.g., the string “alex” may be explicitly length-encoded as “Alias=[4]alex”).

Parameter Arrays are separated using “,” (e.g., “|tag=one,two,three|” or “|tag=1,2,3I”).

Parameters should be placed in order.

Optional parameters may be encoded as null strings.

Online Example:

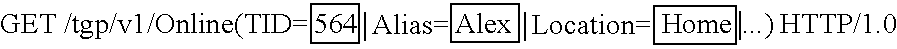

Connection: Keep-Alive
User-Agent: TGClient(OS=WindowsNT4/SP5,Version=6.11,Build=300)
Host: tgp.trulyglobal.com:80
Accept: */*
Accept-Language: en
Accept-Charset: iso-8859-1,*,utf-8

Verb Reply Parameterization

All Verb Replies are contained in a standard HTTP reply body, using the text/plain mime-type. Parameters in verb-replies follow the same conventions as for Verbs.

Online.accept Example:

HTTP/1.0 200
Date: Fri Oct 29 12:32:07 EDT 1999
Server: TGServer(Version=1.01, Build=300)
refresh: 60
Content-Length: 35
Connection: close
Content-type: text/plain

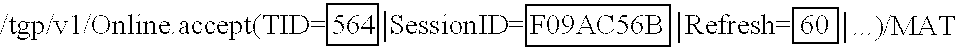

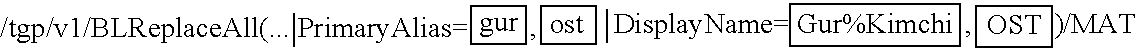

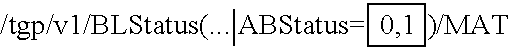

Encoding of Server → Client Transactions

While the client can initiate a connection and transaction (using TCP/HTTP) to the server at any time, the server has no capability to initiate messages of it's own unless a signaling (e.g., TCP) channel is already available.

The solution is for the server to place server-originated transaction(s) in a multi-line client reply. The client periodically sends Online transactions to inform the server that it is on-line, and the server can utilize this medium to send Transactions.

Online.accept & Server Transaction Example:

HTTP/1.0 200
Date: Fri Oct 29 12:32:07 EDT 1999
Server: TGServer(Version=1.01, Build=300)
refresh: 60
Content-Length: 149
Connection: close
Content-type: text/plain
/tgp/v1/Online.accept(...)/ICV

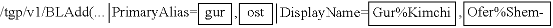

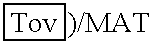

/tgp/v1/Verb1(...)/MAT
/tgp/v1/Verb2(...)/MAT

The client must reply with two messages (using GET) to complete the two server-initiated transactions, (e.g., Buddies.accept and Messages.accept):

Client reply(s) to Server-originated Transaction Example:
GET /tgp/v1/Verb1.accept( . . . )/MAT HTTP/1.0
. . .
GET /tgp/v1/Verb2.accept( . . . )/MAT HTTP/1.0

To which the server can either send another transaction, or reply with an empty body. The client should keep a connected outstanding GET to the server to allow the server to send transactions at any time. The server may close such a connection at any time by returning an empty body.

Outstanding GET Example:
GET /tgp/v1/ HTTP/1.0
Connection: Keep-Alive
. . .

Transport

HTTP 1.0 is used to carry the preferred embodiment present invention protocol transactions. To improve performance and to allow long-lived connections, HTTP 1.1 should be used. TG clients and TG servers must be interoperable with RFC 1945 and may be interoperable with RFC 2068. If an HTTP parameter exists that has a direct correspondence in the present invention protocol the two parameters are not equal, the value in the TG transaction must be used.

The Refresh parameter must be set as per the Online.accept(Refresh)

The pragma: no-cache parameter must be present in the HTTP reply.

The user-agent parameter must be set to the Client's name, followed by “(“, parameters, and a closing “)”.

User-agent parameters must include at least OS:, Version:, and Build: values. These parameters must also be included in the Device-Info parameter.

Client must provide the language it wishes to use when interacting with the service in the Accept-Language: HTTP tag

Procedures

This section describes the operating procedures for both the client and the server using the present invention protocol.

General Procedures

TCP Channel Establishment

The client must resolve the DNS name of the server to an IP address.

The client shall:

open a new TCP connection to the server;

or if a connection is already open and available, use it instead and skip the next two steps.

If the establishment of the TCP connection fails, the client must:

subtract 1 from C2, resolve the DNS name to an IP address again

of the DNS returns more then one IP address, the next IP in the DNS sequence must be used instead of re-resolving the DNS name.

re-attempt to establish the TCP channel after waiting T1.

If C2=0 the client must assume that the service at the provided DNS name is not available and fail.

The client may have an alternate DNS name available and may use it to attempt to reconnect. In that case, the complete procedure must be started from the beginning for the new DNS name, but only after waiting at least T1 *(2*Rand(1.1 to 4)).

The transaction may be resent after re-resolving the DNS name.

The client may try to establish the channel to the same DNS name up to C2 Times.

The client must try to establish the channel to alternate DNS names up to C2 Times.

New requests must reset C2 to its original value.

UDP Virtual Session

If UDP is used for communications, no intrinsic opening procedure is required. Rather, the TGP message must be sent in a complete UDP PDU to the TGP well known port. Servers must reply to the transport address/port from which a UDP/TGP PDU has arrived, and not to the TGP well-known port.

Clients may implement TCP or UDP. Servers must implement both UDP and TCP.

Transaction Procedure

Only the present invention protocol version 1 transactions shall be used.

All transactions and transaction replies (with the exception of the Online transaction) must used the security procedures in the security section to generate a value ICV value.

A unique (to the client) 64 bit monotonically growing sequence number must be generated and put in the transactionID field.

A globally unique ID must be generated and added to the transactionID field.

The C3 value must be added to the transaction ID field.

Experimental Transactions may be used by specifying a “X” prefix. Implementations may ignore “XVerb” transactions they do not understand or do not wish to handle.

The server must reply within T1 with one of *.wait, *.redirect, *.accept, or *.reject.

If a *.wait reply arrives and C1>0 the client must:

If a Online.wait(period) value was provided set the new reply timer to that value, and if not, set the reply time-out to T2

subtract 1 from C1.

If a *.redirect reply arrives the client must:

reset the reply time-out to T1, subtract 1 from C1.

If C1>0, then the client must re-send the original verb to the IP host specified in the *.redirect reply. A new base URL must be used as supplied in the Verb.redirect(Alternate-Base-URL) string. For example, if the original request was sent to:

http://tg.com/tgp/v1/Online( . . . )

and a redirect was returned with the Alternate-Base-URL parameter containing “new/alternate/base”, the client must issue the next request to: http://tg.com/new/alternate/base/tgp/v1/Online( . . . )

If C1=0, the client must abandon the transaction.

If a *.reject reply is received the client must not re-issue the original request, but instead take some local action as necessary.

An *.accept reply terminates the transaction.

After an receiving *.reject or *.accept that Transaction ID must not be reused.

TCP Channel Closing Procedure

Either the client or the server may close the TCP channel at any time as long as no transactions are pending. Such closure is not an error. The client may keep the TCP channel open for as long as required. The server may close the TCP channel at any time.

Presence

Online

The procedure described in the Encoding section must be used.

An Online.accept reply terminates the transaction. The server now considers the client on-line. The client must store the provided Session-ID value for later use.

An Online.reject means the server does not accept the user's request to be on-line.

Refreshing the Online State

When the client receives the Online.accept reply, it must start a timer with an initial value of Online.accept(Period(Refresh)). When this timer expires, it must issue the KeepAlive transaction, including the provided Session-ID this time, using the procedure described in the Encoding section.

The client must assume that the Verb.accept(Refresh) value may change, and use the new value provided in the latest verb.accept reply.

This procedure must be repeated for as long as the client wishes to be considered on-line.

Upon reception of the Online or KeepAlive verbs and authorization of the client, the server must wait until Verb.accept(Refresh) * 3, and if it does not get another Online or KeepAlive verbs from the client, it must consider the client offline.

Offline

When the client wishes to become offline it must issue an Offline transaction. The Session-ID provided in the Online.accept must be provided.

The procedure described in the Encoding section must be used.

An Offline.accept reply terminates the transaction. The server now considers the client off-line.

Placing and Answering Calls

Calling

A client that wishes to call another client must issue a Call transaction to the server providing the alias of the client that it wishes to call. The server may accept the transaction, and if so, the client must call the destinations provided by the server within Call/Call.accept(Call-Within) seconds, providing the Tokens, if any were provided by the server-in signaling protocols. These Tokens could be used to provide authentication and authorization information, for example.

The client may provide 1 or more QoS tokens to the server to request specific QoS level for the call. The server may accept such request and provide a QoS token to the client in the Call/Call.accept reply. The client must use the parameters provided in this QoS token, such as the PHB value. The server may reject the transaction for any reason using the Call.reject reply.

Answering an Incoming Call

When a client receives a call, it must issue a Call/Answer transaction including any Tokens as provided by the calling party. If the server rejects the request to answer the call (using the Call/Answer.reject reply), the client must silently dispose of the call. If the server accepts the request to answer the call, and client must provide some feedback to the user (probably in the form of a ring tone) to allow the user to answer the call.

The client may complete any signaling required to establish the call before receiving the Call/Answer.accept reply, but must not send any media before the user accepts to answer the call.

The client may provide 1 or more QoS tokens to the server to request specific QoS level for the call. The server may accept such request and provide a QoS token to the client in the Call/Answer.accept reply. The client must use the parameters provided in this QoS token, such as the PHB value.

The server may provide the client with a new Online(refresh) period in the Call/Answer.accept reply, and the client must send Online messages to the server using this new Refresh period as long as it is in the call, or until a new refresh period is provided in an Online.accept(refresh).

Informing the Server that the Call Has Started:

When a call is actually started (when media is transmitted in either direction), the client must issue a Call/Started transaction. The server may reject the Call/Started transaction (using a CallStarted.reject), in which case the client must dispose of the call and issue a Call/Ended Transaction with an appropriate reason. The server may provide the called client with a new Online(refresh) period in the Call/Answer.accept reply, and the client must send Online messages to the server using this new Refresh period as long as it is in the call, or until a new refresh period is provided in a Online.accept(refresh).

Informing the Server that the Call is Continuing

The client must provide all Call-IDs of on-going calls in periodical Online transactions sent to the server.

Server Terminating an Active Call

The server may terminate an on-going call by issuing a Call/Terminate transaction with the appropriate Call-ID to both sides of the call. Both clients must release the call and issue Call/Ended transactions to the server.

Informing the Server that the Call Has Ended

When either client terminates the call, both clients must issue Call/Ended transactions. The server may provide the called client with a new Online(refresh) period in the Call/Ended.accept reply, and the client must send Online messages to the server using this new Refresh period as long as it is in the call, or until a new refresh period is provided in a Online.accept(refresh). The client must provide the server with QoS token(s) that represent that quality of the just-completed call.

Terminating Call when Losing Connection to the Service

The client must terminate an active call if it loses connection to the service, but not before following the service-reconnection recovery procedure defined in the Encoding section. Only if the connection to the service fails after C2 * C2 * DNS entries, the client may drop the call. The client must store the call information and transmit the Call/Ended transaction when connection to the service is established at some future time.

Buddy List Procedures

The client maintains a local replica of the server's buddy list. The client may request buddies to be added to the buddy list by issuing the BLAdd transaction. The server may add the requested buddy to the client by issuing an asynchronous BLAdd as a result, but the client does not know the two BLAdd transactions are related.

Data Coherency

The server and client insure data is synchronized by calculating a BLCookie value, and the client must pass the value in every Online transaction. If the server finds out that the client's replica is correct, it will immediately issue the BLStatusAll transaction to update all entry's status. If the server finds out (Server and Client BLCookie values are not equal) that the client is not synchronized, it will update the client's entry list by issuing the BLModifyAll transaction.

Modifying Display Names

The client may request the DisplayName of a buddy to be changed, using the BLModify transaction, the server again may modify the requested buddy in the client by issuing an asynchronous BLModify as a result, but the client does not know the two BLModify transactions are related.

Removing Entries

The client may request the server to remove a buddy from the list, using the BLRemove transaction, the server again may remove the requested buddy from the client by issuing an asynchronous BLRemove as a result, but the client does not know the two BLRemove transactions are related.

Refreshing all Entries

The server may replace the client's buddy list with a completely new list by issuing the BLModifyAll transaction. The client will remove any previous entries and keep only the ones provided by the server. The client may issue the BLModifyAll transaction to get the entire entry list.

Status Changes

An entry's state may be available, unavailable, or unknown. When the state changes, the server must update the client by issuing the BLStatus transaction.

The server may change the state of all entries by issuing the BLStatusAll transaction.

Messaging Procedures

Messaging transactions allow clients to exchange textual and in an extended embodiment, multimedia messages. All messages are sent via the server, i.e. clients never exchange messages directly.

Clients do not store locally messages between runs, e.g. when the client exits it forgets whatever messages it has, and when it starts it receives a fresh list of new and unread messages from the server.

Message Availability Indication

The server will issue a MsgAvailable transaction immediately following the Online.accept transaction to let the client know of any new or unread messages:

C: Online( . . . )

S: Online.accept( . . . ) MsgAvailable( . . . )

Requesting Messages

When the client wishes to read a message, it will request it by issuing the MsgGet transaction containing the message Ids it wishes to receive. The server will reply with an MsgGet.accept containing the message IDs that it will send to the client.

Receiving Messages

The server sends messages (new or as a result of the client issuing the MsgGet transaction) by issuing the Msg transaction. If the Msg is sent as a result of the client requesting it using a MsgGet transaction, the server will put the transaction ID of the MsgGet transaction in the MsgGetTID field in the Msg transaction.

C: MsgGet(TID=5|ID1, ID2, ID3)

S: Msg(TID=6|MsgGetTID=5|ID=1Message Body . . . ) Msg(TID=7|MsgGetTID=5|ID=2|Message Body . . . ) MsgGet.accept(TID=5|ID1, ID2)

If the message is new (e.g., not sent as a result of the client requesting it), the MsgGetTID field in the Msg transaction must be empty.

S: Msg(TID=8|MsgGetTID=*|ID=4|Message Body . . . ) Msg(TID=9|MsgGetTID=*|ID=5|Message Body . . . )

Sending Messages

The client may send messages by issuing the MsgSend transaction. If the message is accepted by the server for delivery it will reply with a MsgSend.accept reply. Acceptance by the server does not guarantee immediate delivery, only guarantees an attempt by the server to deliver the message when possible, as the client may not be currently available.

Changing the Status of a Message

When messages are received by the server their state is set to “new”. Once a message is received by a client it's state is changed to “received”. The client may read and/or delete the message and must report the state change (from “received” to “read” or “deleted”) to the server a-using the MsgStatus transaction.

Message Store Coherency

The server knows the state of the client's message queue by sending the last message ID in the Msgcookie field in MsgAvailable. If the server finds out that the client did not receive the message, it will assume that the client's list is not synchronized with the server, and will issue a MsgFlush transaction to clear the client's message store, then issue a new MsgAvailable with any available (e.g., new and unread) messages.

CODECS:

Codec:
text/plain
text/UTF8
text/html
audio/711.A
audio/711.U
audio/722.16
audio/722.24
audio/722.32
audio/723.1.53
audio/723.1.64
audio/729.A
audio/vsc
audio/gsm
audio/gsm.efr
audio/vhqc
audio/vhqc.48
audio/vhqc.56
audio/vhqc.64
audio/vhqc.96
data/irc
data/ftp
data/netmeeting.Microsoft.com
video/261
video/263
video/263+

Reason Codes:

Reason Classes

| Type | Description |
|---|---|
| Network | Client only errors. Not listed here (DNS failures, TCP |
| Errors | connection, etc) |
| General | Format errors, unknown verbs, unknown fields, missing |
| Protocol | mandatories |
| Errors | |
| Online Errors | Errors reported while a user tried to log into the service |
| Other Errors | Other errors that can be reported by any PDU, almost |
| | any time. Some of which allow the stack to sliently |
| | (without user intervention) recovery. |
| Call Related | Errors during MakeCall, AnswerCall. Also, call |
| | completion status. |
| Buddies | Errors in buddy-list related messages |

Error Codes Table Description

| | Cryprtic name of error. Used as “TGE_xxx” |
|---|---|
| Name | error name constant. |
| TG Exception | Equivalent exception thrown by backend and handled |
| | (converted into reason code) by the frontend |
| Reason code | The code of the error in the protocol |
| Verbs | In what verbs (or equivalent business interface methods) |
| | the error can be raised |
| Action | What client application action is required: |
| | Prompt: requires prompting the user to take an action |
| | Silent: can be handled without user intervention (or even |
| | without user knowledge!) |
| | Indication: the user is notified (sound, GUI), but is not |
| | required to take an immediate action |
| | Fatal: Current “context” cannot continue (Call: |
| | disconnect. Session: need relogin) |

Error Codes Table

| Name | | | Reason | | |
|---|---|---|---|---|---|
| TGE_codes | TG Exception | Description | code | Verbs | Action |
| BAD_VERB | — | Transaction not | 1001 | Unknown | ??? |
| | | supported | | | |
| BAD_PARAM | | Transaction | 1002 | Any | Fatal. |
| | | Corrupted. | | | |
| | | Missing | | | |
| | | fields, etc | | | |
| LOGIN_{—} | AccountNot | Cannot use this | 2001 | Online | Prompt user |
| USER_NOT_FOUND | Active | TGID for login | | | |
| LOGIN_ALREADY_{—} | DeviceAllready | Same Location | 2002 | Online | Change |
| LOGGED_IN | LoggedIn | is used from | | | location (auto, |
| | | another place | | | or prompt user) |
| LOGIN_AUTH_FAIL | Authentication | Wrong | 2003 | Online | Online: prompt |
| | Failed | password | | | user for |
| | | entered by user | | | password. |
| BAD_AUTH | | Failed to | 3001 | All but | Silent relogin |
| | | authenticate | | Online | |
| | | user. | | | |
| UNK_SESSSIONID | Device | Attempt to | 3002 | All but | Silent relogin |
| | NotLoggedIn | make a request | | Online | |
| | | without logging | | | |
| | | in first, or after | | | |
| | | login session | | | |
| | | has expired on | | | |
| | | the server | | | |
| SERVER_DOWN | | Server is down | 3003 | Any | GUI Indication |
| | | (used in wait()) | | | for “no service” |
| UNKNOWN_ERR | ProcessingError | General error | 3004 | Any | Fatal. “should |
| | IllegalArgument | | | | not happen” |
| NO_POLICY | | Self Policy | 3005 | Any | |
| | | denies | | | |
| | | operation (e.g. | | | |
| | | parental | | | |
| | | control) | | | |
| BAD_STATE | | State machine | 3006 | Any | Terminate |
| | | is broken for | | | current “state |
| | | unknown | | | machine” (e.g. |
| | | reason. | | | current call) |
| NO_AUTHZ | Authorization | User not | 3007 | Any | Prompt user |
| | Failed | allowed to | | | |
| | | perform this | | | |
| | | action | | | |
| CALL_{—} | | Normal | 4000 | | |
| NORMAL_{—} | | disconnect | | | |
| DISCONNECT | | | | | |
| CALL_{—} | ResolveFailed | Given | 4001 | Call | Prompt user. |
| CANT_RESOLVE | | destination | | | |
| | | address cannot | | | |
| | | be resolved (= is | | | |
| | | invalid) | | | |
| CALL_{—} | UserNot | Unable to | 4002 | Call | Prompt user. |
| NOT_AVAILABLE | Available | establish call | | | |
| | | with given user | | | |
| CALL_BUSY | | Remote user | 4003 | | |
| | | device is busy | | | |
| CALL_REJECT | | Remote user | 4004 | | |
| | | (or device) | | | |
| | | rejected the call | | | |
| CALL_{—} | | Remote user | 4005 | | |
| USER_NO_ANSWER | | was altered but | | | |
| | | didn't answer | | | |
| CALL_REMOTE_{—} | | Failed to alert | 4006 | | |
| UNAVAILABLE | | remote client | | | |
| CALL_LOW_QOS | | Disconnected | 4007 | | |
| | | due to low | | | |
| | | quality (packet | | | |
| | | loss, delay) | | | |
| CALL_{—} | | | 4008 | | |
| CONNECTION_LOST | | | | | |
| CALL_NO_MEDIA | | Cannot | 4009 | | |
| | | negotiate media | | | |
| CALL_{—} | | | 4010 | | |
| UNSUPPORTED_{—} | | | | | |
| PROTO | | | | | |
| CALL_SERVICE_{—} | | Service | 4011 | Terminate | |
| DISCONNECT | | requested | | Call | |
| | | disconnect | | | |
| CALL_{—} | | Logged out | 4012 | | |
| LOGOUT_{—} | | while client | | | |
| DISCONNECT | | was logged in. | | | |
| CALL GW | | Can't connect | 4013 | | Continue with |
| DISCONNECT ERR | | to GW or Gw | | | next destination |
| | | could not | | | in group |
| | | connect with | | | |
| | | destination | | | |
| BUDDY_{—} | Buddy | Cannot add | 5001 | BLxxx | |
| NO_SUCH_USER | NoSuchUser | buddy with the | | | |
| | | that ID | | | |
| BUDDY_BAD_{—} | Buddy | Buddy | 5002 | BLModify | |
| DISPLAY_NAME | BadDisplayName | DisplayName | | | |
| | | invalid | | | |
| BUDDY_DUP_{—} | Buddy | Buddy | 5003 | BLModify; | |
| DISPLAY_NAME | DupDisplayName | DisplayName | | BLAdd | |
| | | duplicated | | | |
| BUDDY_{—} | Buddy NotInList | Buddy not in | 5004 | BLRemove | |
| NOT_IN_LIST | | BuddyList | | | |
| BUDDY ALREADY | BuddyAlreadyIn | Duplicate | 5005 | BLAdd | |
| EXISTS | List | Buddy Alias | | | |

BuddyList Entry Status Codes:

| State Code | Textual State | Explanation |
|---|---|---|
| 0 | Unknown | State of the address book entry is not known- |
| | | this will be the case initially for non- |
| | | TrulyGlobal subscribers in the address |
| | | book. |
| 1 | Unavailable | User is known to be unavailable. |
| 2 | Available | User is known to be available. |
| 3 | Away | User has not moved the mouse or hit a key |
| | | in X minutes. |
| 4 . . . 255 | reserved | Reserved for future use. |

Messaging Parameters:

Message Status Codes

| State Code | Textual State | Explanation |
|---|---|---|
| 0 | New | The message is on the server and has never |
| | | been delivered to a client. |
| 1 | Received | The message was received by a client, but |
| | | was not read yet |
| 2 | Read | The user read the message. |
| 3 | Deleted | The message was Deleted by a user. |
| 4 . . . 255 | reserved | Reserved for future use. |

Message Types

| State Code | Textual State | Explanation |
|---|---|---|
| 0 | Unused | |
| 1 | Normal | User to User message. |
| 2 | Missed Call | Messages relating to missed calls. |
| 3 | System | System to user message |
| 4 | Message Related | |
| 5 | Buddy Related | |
| 4 . . . 255 | reserved | Reserved for future use. |

Conclusion

A system and method has been shown in the above embodiments for the effective implementation of a robust HTTP based communications protocol. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment and specific computing hardware. Functionally equivalent coding parameters may be substituted for preferred embodiment ones.

The above enhancements and described functional elements are implemented in various computing environments. For example, the present invention may be implemented locally on a conventional server or equivalent, or functionally distributed across multi-nodal systems (e.g., LAN) or networking system (e.g. Internet, WWW, wireless web). All programming and data related thereto are stored in computer memory, static or dynamic, and may be retrieved by the user in any of: conventional computer storage, display (i.e. CRT) and/or hardcopy (i.e., printed) formats. The programming of the present invention may be implemented by one of skill in the art of communications or Internet programming.

1. A communication protocol, said protocol enabling a plurality of communication functions between one or more end user devices and a network connected subscriber server system, said subscriber server system comprising one or more servers, said one or more servers located locally or distributed across said network, said protocol comprising:
a. a plurality of first communication function transactional verbs, said plurality of first communication function transactional verbs comprising requests from said one or more end user devices to said subscriber server system, said first verbs requesting any of, or a combination of: a change of a state in said server system, a search for data available to said server system, or a server action;
b. a plurality of second communication function transactional verbs, said second communication function transactional verbs comprising replies from said subscriber server system and said one or more end user devices comprising a combination of said first transactional verbs and any of: verb wait, verb accept, verb redirect or verb reject;
c. a plurality of third communication function transactional verbs, said plurality of third communication function transactional verbs comprising parameters for said transactions;
d. said first, second and third communication function transactional verbs operatively concatenated to provide multiple transaction groupings, said groupings providing a communication function between said end user device and said server, and
e. said multiple transaction groupings comprising two or more of: presence, policy, calling functions, address book or messaging functions.

2. A communication protocol, said protocol enabling a plurality of communication functions between one or more end user devices and a network connected subscriber server system, as per claim 1, wherein said presence transactional group verbs comprise any of: online, keep alive or offline.

3. A communication protocol, said protocol enabling a plurality of communication functions between one or more end user devices and a network connected subscriber server system, as per claim 1, wherein said calling transactional group verbs comprise any of: call, call answer, call started, call terminate, or call ended.

4. A communication protocol, said protocol enabling a plurality of communication functions between one or more end user devices and a network connected subscriber server system, as per claim 1, wherein said address book comprises at least a buddy list and said address book transactional group verbs comprise any of: buddy list add, buddy list modify, buddy list remove, buddy list modify all, buddy list status, or buddy list status all.

5. A communication protocol, said protocol enabling a plurality of communication functions between one or more end user devices and a network connected subscriber server system, as per claim 4, wherein said subscriber server maintains a master replica of said buddy list and pushes updated lists to said end user devices.

6. A communication protocol, said protocol enabling a plurality of communication functions between one or more end user devices and a network connected subscriber server system, as per claim 4, wherein said buddy lists located at said end user device and subscriber server are synchronized by either cookies or calculation and comparison of a buddy list hash value.

7. A communication protocol, said protocol enabling a plurality of communication functions between one or more end user devices and a network connected subscriber server system, as per claim 1, wherein said messaging transactional group verbs comprise any of: message available, message get, or message send.

8. A communication protocol, said protocol enabling a plurality of communication functions between one or more end user devices and a network connected subscriber server system, as per claim 1, wherein said messaging transactions comprise any of. IM, e-mail, and voice mail.

9. A communication protocol, said protocol enabling a plurality of communication functions between one or more end user devices and a network connected subscriber server system, as per claim 1, wherein said policy transactions comprise any of: list of policies, active policy, and policy change (select).

10. A communication protocol, said protocol enabling a plurality of communication functions between one or more end user devices and a network connected subscriber server system, as per claim 1, wherein said protocol further comprises a transport layer comprising any of: HTTP, TCP, UDP, SSL, IPSEC, XML and TLS.

11. A communication protocol, said protocol enabling a plurality of communication functions between one or more end user devices and a network connected subscriber server system, as per claim 10, wherein said HTTP, TCP, SSL, and TLS protocols provide transparency for said multiple transaction groupings to any of: firewalls, NAT, and proxy servers.

12. A communication protocol, said protocol enabling a plurality of communication functions between one or more end user devices and a network connected subscriber server system, as per claim 1, wherein said transactions use HTTP security including SSL/TLS for transport level encryption.

13. A communication protocol, said protocol enabling a plurality of communication functions between one or more end user devices and a network connected subscriber server system, as per claim 1, wherein said network comprises the Internet and said multiple transaction groupings comprise Internet communication functions.

14. A communication protocol, said protocol enabling a plurality of communication functions between one or more end user devices and a network connected subscriber server system, as per claim 13, wherein said Internet communication functions adhere to the Internet Phone Lite specifications.

15. A communication protocol, said protocol enabling a plurality of communication functions between one or more end user devices and a network connected subscriber server system, as per claim 1, wherein H.323, SIP, RTP, or H248 requirements are used for call function signaling.

16. A communication protocol, said protocol enabling a plurality of communication functions between one or more end user devices and a network connected subscriber server system, as per claim 1, wherein said subscriber server(s) support all of said multiple transaction groupings and said end user device(s) support at least said presence group.

17. A communication protocol, said protocol enabling a plurality of communication functions between one or more end user devices and a network connected subscriber server system, as per claim 1, wherein said subscriber server identifies the specific transaction groupings said end user device supports.

18. A communication protocol, said protocol enabling a plurality of communication functions between one or more end user devices and a network connected subscriber server system, as per claim 1, wherein said verbs in said calling transaction group further comprise quality of service (QoS) tokens.

19. A communication protocol, said protocol enabling a plurality of communication functions between one or more end user devices and a network connected subscriber server system, as per claim 18, wherein said quality of service (QoS) tokens comprise parameters taken from any of, or a combination of: codecs, packet-loss values, jitter values, delay values, and mean opinion scores.

20. A communication protocol, said protocol enabling a plurality of communication functions between one or more end user devices and a network connected subscriber server system, as per claim 18, wherein said quality of service (QoS) tokens are averaged over calling time.

21. A communication protocol, said protocol enabling a plurality of communication functions between one or more end user devices and a network connected subscriber server system, as per claim 1, wherein said first transactional verbs comprise at least a set of generic verb header fields including at least a generic verb request comprising at least: transaction ID, alias, location, session ID, and tokens.

22. An communication protocol, said protocol enabling a plurality of communication functions between one or more end user devices and a network connected subscriber server system, as per claim 21, wherein said first and second transaction verbs comprise generic verb header fields and generic verb accept header field respectively.

23. An communication protocol, said protocol enabling a plurality of communication functions between one or more end user devices and a network connected subscriber server system, as per claim 22, wherein said generic verb accept header field comprises at least: transaction ID, reason transaction is being accepted, reason text, client wait time for refresh, and tokens.

24. An communication protocol, said protocol enabling a plurality of communication functions between one or more end user devices and a network connected subscriber server system, as per claim 1, wherein said transactional verbs include at least one of a request verb transaction or an accept reply transaction verb.

25. An communication protocol, said protocol enabling a plurality of communication functions between one or more end user devices and a network connected subscriber server system, as per claim 24, wherein said request verb transaction includes a base header comprising at least: transaction ID, alias, location, session ID, and tokens and said accept reply transaction verb base header comprises at least: transaction ID, reason transaction is being accepted, reason text, client wait time for refresh, and tokens.

26. An communication protocol, said protocol enabling a plurality of communication functions between one or more end user devices and a network connected subscriber server system, as per claim 1, wherein said end user device resolves a connecting server DNS name to an IP address.

27. An communication protocol, said protocol enabling a plurality of communication functions between one or more end user devices and a network connected subscriber server system, as per claim 1, wherein said transactional verbs further comprise error codes.

28. An communication protocol, said protocol enabling a plurality of communication functions between one or more end user devices and a network connected subscriber server system, as per claim 1, wherein said concatenation follows a pattern of: request-first communication function transactional verbs plus third communication function transactional verbs and reply-first communication function transactional verbs plus second communication function transactional verbs plus third communication function transactional verbs.

29. An communication protocol, said protocol enabling a plurality of communication functions between one or more end user devices and a network connected subscriber server system, said subscriber server system comprising one or more servers, said one or more servers located locally or distributed across said network, said protocol comprising:
a. a set of generic verb header fields;
b. a plurality of transaction verbs, said transaction verbs comprising specific fields appended to at least one generic verb header field from said set of generic header fields;
c. a first grouping of transaction verbs, said first grouping providing end user device presence information to said subscriber server system;
d. a second grouping of transaction verbs, said second grouping providing call functions between said end user device and one or more remote devices through said subscriber server system;
e. a third grouping of transaction verbs, said third grouping providing messaging functions between said end user device and one or more remote devices through said subscriber server system;
f. a fourth grouping of transaction verbs, said fourth grouping providing address book functions between said end user device and said subscriber server system, and
g. a fifth grouping of transaction verbs, said fifth grouping providing policy functions between said end user device and said subscriber server system.

30. An communication protocol, said protocol enabling a plurality of communication functions between one or more end user devices and a network connected subscriber server system, as per claim 29, wherein said presence transaction verbs comprise any of: online, keep alive or offline.

31. An communication protocol, said protocol enabling a plurality of communication functions between one or more end user devices and a network connected subscriber server system, as per claim 29, wherein said calling transaction verbs comprise any of: call, call answer, call started, call terminate, or call ended.

32. An communication protocol, said protocol enabling a plurality of communication functions between one or more end user devices and a network connected subscriber server system, as per claim 29, wherein said messaging transaction verbs comprise any of: message available, message get, or message send.

33. An communication protocol, said protocol enabling a plurality of communication functions between one or more end user devices and a network connected subscriber server system, as per claim 29, wherein said messaging transactions comprise any of: IM, e-mail, and voice mail.

34. An communication protocol, said protocol enabling a plurality of communication functions between one or more end user devices and a network connected subscriber server system, as per claim 29, wherein said address book comprises at least a buddy list and said address book transaction verbs include any of: buddy list add, buddy list modify, buddy list remove, buddy list modify all, buddy list status, or buddy list status all.

35. An communication protocol, said protocol enabling a plurality of communication functions between one or more end user devices and a network connected subscriber server system, as per claim 29, wherein said policy functions comprise any of: list of policies, active policy, and policy change (select).

36. An communication protocol, said protocol enabling a plurality of communication functions between one or more end user devices and a network connected subscriber server system, as per claim 34, wherein said subscriber server maintains a master replica of said buddy list and pushes updated lists to said end user devices.

37. An communication protocol, said protocol enabling a plurality of communication functions between one or more end user devices and a network connected subscriber server system, as per claim 36, wherein said buddy lists located at said end user device and subscriber server are synchronized by calculation and comparison of a buddy list hash value.

38. A communication protocol, said protocol enabling a plurality of communication functions between one or more end user devices and a network connected subscriber server system, as per claim 29, wherein said protocol further comprises a transport layer comprising any of: HTTP, TCP, UDP, SSL, IPSEC, XML and TLS.

39. A communication protocol, said protocol enabling a plurality of communication functions between one or more end user devices and a network connected subscriber server system, as per claim 38, wherein said HTTP, TCP, SSL, and TLS protocols provide transparency for said multiple transaction groupings to any of: firewalls, NAT, and proxy servers.

40. An communication protocol, said protocol enabling a plurality of communication functions between one or more end user devices and a network connected subscriber server system, as per claim 29, wherein said transactions use HTTP security including SSL/TLS for transport level encryption.

41. An communication protocol, said protocol enabling a plurality of communication functions between one or more end user devices and a network connected subscriber server system, as per claim 29, wherein said network comprises the Internet and said first, second, third, fourth, and fifth transaction groupings comprise Internet communication functions.

42. An communication protocol, said protocol enabling a plurality of communication functions between one or more end user devices and a network connected subscriber server system, as per claim 41, wherein said Internet communication functions adhere to the Internet Phone Lite specifications.

43. An communication protocol, said protocol enabling a plurality of communication functions between one or more end user devices and a network connected subscriber server system, as per claim 29, wherein H.323, SIP, RTP, or H248 requirements are used for call finction signaling.

44. An communication protocol, said protocol enabling a plurality of communication functions between one or more end user devices and a network connected subscriber server system, as per claim 29, wherein said subscriber server(s) support all of said transaction groupings and said end user device(s) support at least said first group.

45. An communication protocol, said protocol enabling a plurality of communication functions between one or more end user devices and a network connected subscriber server system, as per claim 29, wherein said server identifies the specific transaction groupings said end user device supports.

46. An communication protocol, said protocol enabling a plurality of communication functions between one or more end user devices and a network connected subscriber server system, as per claim 29, wherein said call transaction verbs further comprise quality of service (QoS) tokens.

47. An communication protocol, said protocol enabling a plurality of communication functions between one or more end user devices and a network connected subscriber server system, as per claim 46, wherein said quality of service (QoS) tokens comprise parameters taken from any of, or a combination of: codecs, packet-loss values, jitter values, delay values, and mean opinion scores.

48. An communication protocol, said protocol enabling a plurality of communication functions between one or more end user devices and a network connected subscriber server system, as per claim 46, wherein said quality of service (QoS) tokens are averaged over calling time.

49. An communication protocol, said protocol enabling a plurality of communication functions between one or more end user devices and a network connected subscriber server system, as per claim 29, wherein said set of generic verb header fields includes at least a generic verb request comprising at least: transaction ID, alias, location, session ID, and tokens.

50. An communication protocol, said protocol enabling a plurality of communication functions between one or more end user devices and a network connected subscriber server system, as per claim 29, wherein said set of generic verb header fields includes at least a generic verb accept header field.

51. An communication protocol, said protocol enabling a plurality of communication functions between one or more end user devices and a network connected subscriber server system, as per claim 50, wherein said generic verb accept header field comprises at least: transaction ID, reason transaction is being accepted, reason text, client wait time for refresh, and tokens.

52. An communication protocol, said protocol enabling a plurality of communication functions between one or more end user devices and a network connected subscriber server system, as per claim 29, wherein said transaction verbs include at least a request verb transaction and an accept reply transaction verb.

53. An communication protocol, said protocol enabling a plurality of communication functions between one or more end user devices and a network connected subscriber server system, as per claim 52, wherein said request verb transaction includes a base header comprising at least: transaction ID, alias, location, session ID, and tokens and said accept reply transaction verb base header comprises at least: transaction ID, reason transaction is being accepted, reason text, client wait time for refresh, and tokens.

54. An communication protocol, said protocol enabling a plurality of communication functions between one or more end user devices and a network connected subscriber server system, as per claim 29, wherein said end user device resolves a connecting server DNS name to an IP address.

55. An communication protocol, said protocol enabling a plurality of communication functions between one or more end user devices and a network connected subscriber server system, as per claim 29, wherein said transaction verbs further comprise error codes.

56. A communications system including a protocol providing communication functions over a network, one or more of the elements of said system implemented on one or more servers located across said network, said communications system comprising:
one or more subscriber servers;
a plurality of clients, said clients operatively connected to at least one of said one or more subscriber servers over said network;
a transport protocol operative across said network;
a transaction based verb protocol overlaid on said transport protocol;
said transaction based verb protocol grouped into multiple verb families;
said multiple verb families comprising at least two of the group: presence, policy, calling, messages, and address book.

57. A communications system including a protocol providing communication functions over a network, as per claim 56, wherein said at least two comprises said presence family and one family from the remaining group: calling, policy, messages, and address book.

58. A communication protocol, said protocol enabling a plurality of communication functions between one or more end user devices and a network connected subscriber server system, as per claim 56, wherein said transport layer comprises any of: HTTP, TCP, UDP, SSL, IPSEC, XML and TLS.

59. A communications system including a protocol providing communication functions over a network, as per claim 56, wherein said multiple verb families comprise all from the group: presence, calling, policy, messages, and address book.

60. An Internet communication system, one or more of the elements of said system implemented between one or more client devices and one or more servers located across said Internet, said communications system comprising:
a subscriber server, said subscriber server comprising one or more connected servers located on said Internet, said subscriber server providing said one or more client devices with Internet communication functions;
a communications protocol comprising a verb based transactional protocol overlaid onto a transport, said communications protocol providing said Internet communication functions between said one or more client devices and said subscriber server, said communications protocol including multiple verb families, and said multiple verb families comprising at least two of the group: presence, policy, calling, messages, and address book.

61. An Internet communication system, as per claim 60, wherein said at least two comprises said presence family and one family from the remaining group: calling, policy, messages, and address book.

62. An Internet communication system, as per claim 60, wherein said multiple verb families comprise all from the group: presence, policy, calling, messages, and address book.

63. An Internet communication system, as per claim 60, wherein said transport layer comprising any of: HTTP, TCP, UDP, SSL, IPSEC, XML and TLS.

64. A communication method providing communication functions over an communication network, one or more steps of said method implemented on one or more servers located across said network, said communications method comprising:
overlaying a communications protocol comprising a plurality of transaction verbs on a transport;
operatively connecting one or more clients to one or more subscriber servers, said clients operatively connected to at least one of said one or more subscriber servers over said network using said communications protocol;
selecting a series of correlating transaction based verbs from said communications protocol based on a desired communication function;
said transaction based verbs grouped into multiple verb families based on said desired communication function, and
said multiple verb families comprising at least two of the group: presence, policy, calling, messages, and address book.

65. A communication method providing communication functions over a communication network, as per claim 64, wherein said at least two comprises said presence family and one family from the remaining group: calling, policy, messages, and address book.

66. A communication method providing communication functions over an communication network, as per claim 64, wherein said multiple verb families comprise all from the group: presence, policy, calling, messages, and address book.

67. A communication protocol, said protocol enabling a plurality of communication services across a network, said protocol comprising:
a. a plurality of first communication function transactional verbs, said plurality of first communication function transactional verbs comprising requests for communication services, said first verbs each comprising a generic verb header and one or more parameters for specified transactions;
b. a plurality of second communication function transactional verbs comprising responses to said first communication function transactional verbs, said responses comprising a combination of said first communication function transactional verbs and any of: verb wait, verb accept, verb redirect or verb reject, and one or more parameters for specified transactions;
c. said first and second communication function transactional verbs operative to provide multiple transaction groupings, said groupings providing said communication services between a requestor and responder, and
d. said multiple transaction groupings comprising two or more of: presence, policy, calling functions, address book or messaging functions.
